(19) United States
(12) Patent Application Publication
(10) Pub. No.: US 2024/0309145 A1
(43) Pub. Date: Sep. 19, 2024

(54) PRODUCTION OF PU FOAMS

(71) Applicant: Evonik Operations GmbH, Essen (DE)

(72) Inventors: Annegret Terheiden, Alpen (DE); Jens Hildebrand, Johannesberg (DE); Natalia Hinrichs-Tontrup, Alzenau (DE); Daniela Hermann, Duesseldorf (DE)

(73) Assignee: Evonik Operations GmbH, Essen (DE)

(21) Appl. No.: 18/575,870

(22) PCT Filed: Jun. 28, 2022
(86) PCT No.: PCT/EP2022/067706

§ 371 Date: Jan. 1, 2024

(30) Foreign Application Priority Data
Jul. 2, 2021 (EP) 21183445.2

(51) Int. Cl. C08G 18/48; C08G 18/16; C08G 18/18; C08G 18/24; C08G 18/76; C08J 11/28; C08L 75/08

(52) U.S. Cl. CPC C08G 18/4829; C08G 18/165; C08G 18/18; C08G 18/1825; C08G 18/244; C08G 18/7621; C08J 11/28; C08L 75/08; C08G 2110/0008; C08G 2110/005; C08G 2110/0058; C08G 2110/0066; C08G 2110/0083; C08J 2375/08; C08L 2201/08; C08L 2203/14

(57) ABSTRACT

A process for producing PU foams, preferably flexible PU foams, can be performed by reacting at least one polyol component, comprising a recycled polyol, with at least one isocyanate component in the presence of one or more catalysts that catalyse the isocyanate-polyol and/or isocyanate-water reactions and/or isocyanate trimerization. The recycled polyol is obtained by hydrolysis of a polyurethane, by contacting said polyurethane with water in the presence of a specific base-catalyst-combination.

The present invention is in the field of PU foams. It relates more particularly to a process for producing PU foams, preferably flexible PU foams, using recycled polyol.

Polyurethane foams (PU foams) are known per se. These are cellular and/or microcellular polyurethane materials. They can be divided into classes including closed-cell or partly closed-cell rigid PU foams and open-cell or partly open-cell flexible PU foams. Rigid PU foams are used predominantly as insulation materials, for example in refrigerator systems or in the thermal insulation of buildings. Flexible PU foams are used in a multitude of technical applications in the industry and the domestic sector, for example for sound deadening, for production of mattresses or for cushioning of furniture. Examples of particularly important markets for various types of PU foams, such as flexible PU foams, are related to mattresses and furniture in homes, offices and the like. A further particularly important market for flexible PU foams is the automotive industry.

It is known that millions of tons of polyurethane foams (PU foams) are produced worldwide every year, which are used as insulation materials, mattresses, upholstery or technical foams, for example. At the same time, huge amounts of production waste are generated annually in production of PU foams alone. In addition, there is the huge amount of disused PU foams, e.g. in the form of mattresses that are renewed after a few years. So, there is a very huge amount of recyclable PU material available.

Against this background, there have been many efforts to obtain recycled polyols from PU waste. Various technologies for chemical recycling already exist, such as glycolysis, aminolysis, acidolysis and hydrolysis. In addition, processes to produce PU foams have been worked on, that enable the use of recycled polyol. The results of work in this area have so far not been satisfactory because the product quality of the resulting PU foams was not convincing, particularly with regards to the provision of flexible PU foam. The physical and mechanical properties of the resulting PU foams produced from recycled polyol did not reach the level of PU foams made without the use of recycled polyols. Therefore, the amount of recycled polyol used in these processes had to be limited, usually up to a recycled polyol content of not greater than 30%, in order to preserve the product quality of the resulting foam, particularly with a view to the provision of flexible PU foams.

Thus, there is still a need to provide a process which allows the production of flexible PU-foam with significantly larger amounts of recycled polyol while maintaining the known quality of flexible PU foams based on oil-derived virgin polyols.

The specific objective of our invention was therefore to provide a process for the production of PU foam, preferably flexible PU foam, that allows the use of larger amounts of recycled polyol while maintaining the previously known product quality of PU foams, preferably flexible PU foams that were produced without the use of recycled polyol, with regard to the physical and mechanical properties of the resulting PU foams.

This objective was achieved by the subject matter of our invention. The subject matter of our invention is a process for producing PU foams, preferably flexible PU foams, by reacting
(a) at least one polyol component, comprising recycled polyol
with
(b) at least one isocyanate component
in the presence of
(c) one or more catalysts that catalyse the isocyanate-polyol and/or isocyanate-water reactions and/or isocyanate trimerization, and
(d) optionally further additives,
characterized in that the recycled polyol was obtained by hydrolysis of a polyurethane, comprising contacting said polyurethane with water in the presence of a base-catalyst-combination (I) or (II),
(I) comprises a base having a pK_{b} value at 25° C. of from 1 to 10, and a catalyst selected from the group consisting of quaternary ammonium salts containing an ammonium cation containing 6 to 30 carbon atoms and organic sulfonates containing at least 7 carbon atoms, or
(II) comprises a strong inorganic base having a pK_{b} value at 25° C. of <1, and as catalyst a quaternary ammonium salt containing an ammonium cation containing 6 to 14 carbon atoms if the ammonium cation does not comprise a benzyl residue or containing 6 to 12 carbon atoms if the ammonium cation comprises a benzyl residue.

Components (a) to (d) are known per se; they are described more specifically further down. The recycled polyol obtained by hydrolysis of a polyurethane, comprising contacting said polyurethane with water in the presence of a base-catalyst-combination (I) or (II), is described in more detail further down.

Advantageously, the inventive process allows the production of PU foam, preferably flexible PU foam under the use of larger amounts of recycled polyol while maintaining the previously known product quality of flexible PU foams that were produced without the use of recycled polyol, with regard to the physical and mechanical properties of the resulting PU foams. An inventive process wherein the recycled polyol content is >25% by weight, preferably >30% by weight, further preferred >50% by weight, even more preferred >75% by weight, again further preferred >90% by weight, in particular is 100% by weight, based on the total polyol content, corresponds to a preferred embodiment of our invention. Even with 100% use of the recycled polyol, there is no negative impact whatsoever on the physical and mechanical foam properties and also there is no negative impact on the foaming process.

As a further advantage the inventive process allows the production of PU foams, preferably flexible PU foams which are particularly low in emissions with regard to volatile organic compounds. What is meant more particularly in the context of the present invention by “low in emissions” is that the PU foam, preferably flexible PU foam that results in accordance with the invention preferably has an emission of ≥0 μg/m³ to ≤500 μg/m³, more preferably ≤250 μg/m³, even more preferably ≤150 μg/m³, appropriately determined by the test chamber method based on DIN EN ISO 16000-9:2008-04, 24 hours after test chamber loading. This method is described precisely in EP 3205680A1, specifically in paragraph [0070], which is hereby incorporated by reference.

As a further advantage the resulting inventive PU foam can also meet emissions specifications such as CertiPur. What is meant here by low in emissions according to CertiPur is that total emissions of volatile organic substances (TVOCs) are preferably less than 500 μg/m³, determined according to the method ISO 16000-9 and ISO 16000-11. Further technical details of the requirements for the CertiPUR standard (Version 1. July 2017) can be found at: https://www.europur.org/images/CertiPUR_Technical_Paper_-_Full_Version_-_2017.pdf. This latter document (Version 1. July 2017) can also be ordered directly at EUROPUR, Avenue de Cortenbergh 71, B-1000 Brussels, Belgium.

As a further advantage the resulting inventive PU foam can advantageously also meet emissions specifications relevant for the automotive industry such as VDA 278 (May 2016). VDA is the German Association of the Automotive Industry (www.vda.de). “Low-emission” according to VDA 278 (May 2016) means that the PU foams fulfills the Daimler emission specification DBL 5430 (edition 2019-07).

As a further advantage the resulting inventive PU foam can advantageously also meet further emission specifications relevant for the automotive industry such as GS 97014-3:2014-04 (DIN ISO 12219-4:2013-12), also called the BMW summertest where emissions are measured in a chamber of 0.98 m³ with an air exchange rate of 0.4/h after conditioning at 65° C. for 4 h. Hydrocarbons are sampled in a Tenax tube and analyzed by GC-MS while aldehydes are sampled in a DNPH (dinitrophenylhydrazine) cartridge and subjected to HPLC.

As a further advantage the resulting inventive PU foam can advantageously also meet further emission specifications relevant for the automotive industry such as VDA 276 (December 2005), (DIN ISO 12219-4:2013-12/DIN ISO 12219-6:2017-08), where emissions are measured in a chamber of 1 m³ with an air exchange rate of 0.4/h after conditioning at 65° C. for 2 h. Hydrocarbons are sampled in a Tenax tube and analyzed by GC-MS while aldehydes are sampled in a DNPH (dinitrophenylhydrazine) cartridge and subjected to HPLC.

As a further advantage the resulting inventive PU foam can advantageously also meet further emission specifications relevant for the automotive industry such as Toyota TSM0510G-A where emissions are measured in a chamber of 1 m³ at an air exchange rate of 0.4/h at 65° C. for 2 h and Toyota TSM0508G where the test specimen is put in a tedlarbag together with nitrogen gas and conditioned at 65° C. for 2 h. For both Toyota methods hydrocarbons are sampled in a Tenax tube and analyzed by GC-MS while aldehydes are sampled in a DNPH (dinitrophenylhydrazine) cartridge and subjected to HPLC.

As a further advantage the resulting inventive PU foams are particularly low in emissions with respect to aldehydes, preferably comprising emissions of formaldehyde, acetaldehyde, propionaldehyde, acrolein and benzaldehyde, especially propionaldehyde. A person skilled in the art is aware of different analytical methods for determining aldehyde emissions. VDA 275 (July 1994), VDA 277 (January 1995) or else VDA 278 (May 2016) may be cited by way of example, as may various chamber test methods, some examples are given in the aforementioned paragraph. VDA 275 (July 1994) provides an analytical method for determining the formaldehyde release by the modified bottle procedure. The process according to the invention can produce polyurethane foams that are particularly low in emissions of aldehydes, preferably comprising emissions of formaldehyde, acetaldehyde, propionaldehyde, acrolein, and also aromatic aldehydes, such as benzaldehyde, advantageously aldehyde emissions comprising formaldehyde, propionaldehyde, acetaldehyde, acrolein and benzaldehyde, especially aldehyde emissions comprising formaldehyde, propionaldehyde and acetaldehyde from polyurethane systems (especially polyurethane foam).

A further advantage is that the resulting inventive PU foam allows the production of PU foam, preferably flexible PU foam under the use of larger amounts of recycled polyol while maintaining the previously known odor characteristics of PU foams, preferably flexible PU foams, that were produced without the use of recycled polyol.

The subject-matter of the invention will be described by way of example below, without any intention that the invention be restricted to these illustrative embodiments. Where ranges, general formulae or classes of compounds are specified below, these are intended to encompass not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are figures in percent by weight. When average values are reported below, the values in question are weight averages, unless stated otherwise. Where parameters which have been determined by measurement are reported below, the measurements have been carried out at a temperature of 25° C. and a pressure of 101 325 Pa, unless stated otherwise.

Polyurethane (PU) in the context of the present invention is especially understood to mean a product obtainable by reaction of polyisocyanates and polyols, or compounds having isocyanate-reactive groups. Further functional groups in addition to the polyurethane can also be formed in the reaction, examples being uretdiones, carbodiimides, isocyanurates, allophanates, biurets, ureas and/or uretonimines. Therefore, for the purposes of the present invention, polyurethanes are all reaction products derived from isocyanates, in particular polyisocyanates, and appropriately isocyanate-reactive molecules. These include polyisocyanurates, polyureas, and allophanate-, biuret-, uretdione-, uretonimine- or carbodiimide-containing isocyanate or polyisocyanate reaction products. Preferred PU foams are flexible PU foams. Particular preference is given in this context to hot-cure flexible polyether PU foams, polyester PU foams, highly resilient cold-cure polyurethane foams (also referred to hereinafter as “high-resilience”, i.e. HR PU foams), viscoelastic PU foams and hypersoft PU foams, and also PU foams which have properties between these classifications and are used in the automobile industry. More particularly, all the aforementioned PU foam types are covered by the invention.

It will be apparent that a person skilled in the art seeking to produce the different PU foam types, preferably flexible PU foam types, for example hot-cure flexible, high resilient cold-cure, viscoelastic, hypersoft or ester type flexible PU foams, will appropriately select the substances necessary for the purpose in each case, e.g. isocyanates, polyols, stabilizers, surfactants, etc., in order to obtain the desired PU foam type.

In the context of the present invention the term flexible PU foams preferably comprise hot-cure flexible PU foam, high resilient cold-cure PU foam, viscoelastic PU foam, hypersoft and/or ester type flexible PU foams.

The terms flexible hot-cure, high resilient cold-cure, viscoelastic, hypersoft or ester type flexible PU foams are known per se to the person skilled in the art; this are fixed technical terms which are correspondingly established in the specialist field, but will nevertheless be elucidated briefly here.

Flexible PU foams are elastic and deformable and usually have open cells. In the context of the present invention, “open-cell” means that a foam has good air permeability (=porosity). The air permeability of the foam can be determined by dynamic pressure measurement on the foam. The dynamic pressure can be measured in accordance with DIN EN ISO 4638:1993-07. When the measured dynamic pressure is reported in mm of water column, open-cell PU foams, especially flexible PU foams, have a dynamic pressure of preferably below 100 mm, more preferably ≥50 mm of water column, as determined by the method of measurement described in the examples. As a result, the air can escape easily on compression.

In addition, there are also rigid PU foams that are inelastic and usually have closed cells. These rigid foams are used for insulation purposes and are not in the preferred focus of the present invention.

The known and fundamental difference between flexible foam and rigid foam is that flexible foam shows elastic characteristics and hence deformation is reversible. By contrast, rigid foam is permanently deformed. In the context of the present invention, rigid polyurethane foam is especially understood to mean a foam to DIN 7726:1982-05 that has a compressive strength to DIN 53 421:1984-06 of advantageously ≥20 kPa, preferably ≥80 kPa, more preferably ≥100 kPa, further preferably ≥150 kPa, especially preferably ≥180 kPa. In addition, the rigid polyurethane foam, according to DIN EN ISO 4590:2016-12, advantageously has a closed-cell content of greater than 50%, preferably greater than 80% and more preferably greater than 90%.

There exists a wide variety of flexible PU foams. For instance, the person skilled in the art is aware inter alia of ester foams (made from polyester polyols), hot-cure flexible PU foams and cold-cure PU foams. The crucial difference between a hot-cure flexible PU foam and a cold-cure PU foam lies in the different mechanical properties. It is possible to differentiate between hot-cure flexible PU foams and cold-cure PU foams via rebound resilience in particular, also called ball rebound (BR) or resilience. A method of determining the rebound resilience is described, for example, in DIN EN ISO 8307:2008-03. Here, a steel ball having a fixed mass is dropped from a particular height onto the test specimen and the height of the rebound in % of the drop height is measured. The values in question for a cold-cure flexible PU foam are preferably in the region of >50%. Cold-cure flexible PU foams are therefore also often referred to as HR foams (HR: High Resilience). By contrast, hot-cure flexible PU foams have rebound values of preferably 1% to not more than 50%. A further mechanical criterion is the SAG or comfort factor. In this case, a foam sample is compressed in accordance with DIN EN ISO 2439:2009-05 and the ratio of compressive stress at 65% and 25% compression is measured. Cold-cure flexible PU foams here have a SAG or comfort factor of preferably >2.5. Hot-cure flexible PU foams have a value of preferably <2.5.

An exact definition of the properties can also be taken, for example, from the data sheet “PUR-Kaltschaum” [Cold-Cure PU Foam] from the Fachverband Schaumkunststoffe und Polyurethane e.V. [Specialist Association Foamed Plastics and Polyurethanes], Reference KAL20160323, last update 23 Mar. 2016. (https://www.fsk-vsv.de/wp-content/uploads/2017/03/Produktbeschreibung-PUR-Kaltschaum.pdf). This data sheet can also be ordered directly from the Fachverband Schaumkunststoffe und Polyurethane e.V. (FSK), postal address: Stammheimerstr. 35, D-70435 Stuttgart.

The two names hot-cure flexible PU foam and cold-cure flexible PU foam are explained by the historical development of PU technology, and do not necessarily mean that different temperatures occur in the foaming process.

The different mechanical properties of hot-cure flexible PU foams and cold-cure PU foams result from differences in the formulation for production of these foams. In the case of a cold-cure flexible PU foam, predominantly high-reactivity polyols having primary OH groups and average molar mass >4000 g/mol are preferably used. Optionally, low molecular weight crosslinkers are also used, and it is also possible that the function of the crosslinker is assumed by higher-functionality isocyanates. In the case of hot-cure flexible PU foams, comparatively less reactive polyols having secondary OH groups and an average molar mass of <4000 g/mol are preferably used. In the case of cold-cure flexible PU foams, the reaction of the isocyanate groups with the hydroxyl groups thus occurs as early as in the expansion phase (CO₂ formation from —NCO and H₂O) of the foam. This rapid polyurethane reaction usually leads, as a result of a viscosity increase, to a relatively high intrinsic stability of the foam during the rising process. As a result, other foam stabilizers with different siloxane structures compared to hot-cure flexible PU foams are required. Cold-cure flexible PU foams are usually highly elastic foams. Due to the high intrinsic stability, the cells have generally not been opened sufficiently at the end of the foaming process and the cell structure additionally has to be opened by mechanical crushing. In the case of hot-cure flexible PU foams, by contrast, this is normally not necessary.

Depending on the application, hot-cure flexible PU foams preferably have a foam density between 8 and 80 kg/m³. Especially when such hot-cure flexible PU foams are used as mattresses, mattress constituents and/or cushions, said foams are differentiated according to regional requirements and preferences of consumers. The preferred hot-cure flexible PU foam for mattress applications has a foam density of preferably 25-50 kg/m³.

A further class of flexible PU foams in the context of this invention are viscoelastic PU foams. These are also known as “memory foam” and exhibit both a low rebound resilience (preferably <15%) and a slow, gradual recovery after compression (recovery time preferably 2-13 s). Materials of this kind are well known in the prior art and are highly valued for their energy- and sound-absorbing properties, too. Typical viscoelastic flexible foams usually have a lower porosity and a higher density (or a high foam density (FD)) compared to standard hot-cure flexible PU foams. Cushions have a foam density of preferably 30-50 kg/m³ and are thus at the lower end of the density scale which are typical for viscoelastic foams, whereas viscoelastic PU foams for mattresses preferably have a density in the range of 50-130 kg/m³.

In flexible PU foams, the hard (high glass transition temperature) and soft (low glass transition temperature) segments become oriented relatively to each other during the reaction and then spontaneously separate from one another to form morphologically different phases within the “bulk polymer”. Such materials are also referred to as “phase-separated” materials. The glass transition temperature in the case of viscoelastic foams is preferably between −20 and +22° C. The glass transition temperature of standard hot-cure flexible PU foams and cold-cure flexible PU foams, by contrast, is preferably below −32° C. Such “structural viscoelasticity” in the case of open-cell viscoelastic flexible PU foams which is based essentially on the glass transition temperature of the polymer, should be distinguished from a pneumatic effect. In the latter case, the cell structure is relatively closed resulting in low porosity. As a result of the low air permeability, after compression of the foam the air flows back in only gradually, which results in delayed recovery.

A further class of flexible PU foams in the context of this invention are hypersoft PU foams. The hardness level of hypersoft foams is significantly lower than for standard hot-cure flexible foams which are used for mattress cores. Hypersoft foams are extremely resilient and supple. It can be distinguished between two categories of hypersoft flexible foams related to the manufacturing process: hypersoft PU foams produced by using so-called hypersoft polyols in combination with conventional type polyols and/or by using a special process in which carbon dioxide is dosed during the foaming process. For both manufacturing processes, particularly soft foams are obtained showing compressive stress values determined in accordance with DIN EN ISO 3386-1:1997+A1:2010 of below 2.0 kPa or indentation hardness values determined in accordance to DIN EN ISO 2439:2009-05 of below 80 N. The so-called hypersoft polyols are characterized by the fact that they contain more than 60% primary OH groups at the end of the polyether chain. Hypersoft PU foams show a high air permeability and therefore promote the transport of moisture which reduces the risk of heat accumulation.

Various hot-cure flexible PU foams are classified not only according to foam density but often also according to their compressive strength, also referred to as load-bearing capacity, for particular applications. For instance, compressive strength CLD (compression load deflection), 40% in accordance with DIN EN ISO 3386-1:1997+A1:2010, for hot-cure flexible PU foams is preferably in the range of 2.0-8.0 kPa; viscoelastic polyurethane foams preferably have values of 0.1-5.0 kPa, especially 0.5-4.0 kPa; hypersoft foams preferably have values below 2.0 kPa.

In a preferred embodiment of the invention, the flexible PU foams to be used in accordance with the invention have the following preferred properties in respect of rebound resilience, foam density and/or porosity: a rebound resilience of 1% to 80%, measured in accordance with DIN EN ISO 8307:2008-03, and/or a foam density of 5 to 800 kg/m³, especially 5 to 300, more preferably 5 to 150 and especially preferably of 10 to 90 kg/m³, measured in accordance with ASTM D 3574-11, and/or a porosity of 1 to 250 mm water column, in particular 1 to 50 mm water column, measured in accordance with DIN ISO 4638:1993-07.

In the inventive production of PU foams, preferably flexible PU foams, preference is given to reacting at least one polyol component and at least one isocyanate component in the presence of at least one blowing agent (e.g. water) in a polyaddition reaction, optionally in the presence of catalysts and/or further additives, with use of recycled polyol in accordance with the requirements of claim 1.

Further details of the usable starting materials, catalysts, auxiliaries and additives can also be found, for example, in Kunststoffhandbuch [Plastics Handbook], volume 7, Polyurethane [Polyurethanes], Carl-Hanser-Verlag Munich, 1st edition 1966, 2nd edition 1983 and 3rd edition 1993. The compounds, components and additives below are usable with preference.

The isocyanate components used are preferably one or more organic polyisocyanates having two or more isocyanate functions. As polyol components preferably one or more polyols are used, which preferably have two or more OH groups, wherein the polyol component of the invention necessarily contains recycled polyol.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Preferably, isocyanates are used within a range from 60 to 350 mol %, more preferably within a range from 60 to 140 mol %, relative to the total sum of isocyanate-consuming components.

Specific examples are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates can be used individually or in the form of mixtures thereof.

It is also possible to use isocyanates which have been modified by the incorporation of urethane, uretdione, isocyanurate, allophanate and other groups, called modified isocyanates.

Particularly suitable organic polyisocyanates which are therefore used with particular preference are various isomers of tolylene diisocyanate (tolylene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived thereof. Examples of particularly suitable isocyanates are detailed, for example, in EP 1712578, EP 1161474, WO 00/58383, US 2007/0072951, EP 1678232 and WO 2005/085310, which are hereby fully incorporated by reference.

According to the invention, certain recycled polyols are used as defined in claim 1. In addition, other polyols may also be used optionally.

These optional polyols are described hereinafter: Optional polyols suitable for the purposes of the present invention are all organic substances having two or more isocyanate-reactive groups, preferably OH groups, and also formulations thereof. Preferred polyols include any polyether polyols and/or polyester polyols and/or hydroxyl-containing aliphatic polycarbonates, especially polyether polycarbonate polyols and/or natural oil-based polyols (NOPs) that are typically used for production of polyurethane systems, especially PU foams. The polyols usually have a functionality of 1.8 to 8 and number-average molecular weights preferably in the range from 500 to 15 000 g/mol. The polyols are preferably used with OH numbers in the range from 10 to 1200 mg KOH/g. The number-average molecular weights are typically determined by gel permeation chromatography (GPC), especially using polypropylene glycol as reference substance and tetrahydrofuran (THF) as eluent. The OH numbers can be determined, in particular, in accordance with the DIN standard DIN 53240:1971-12.

Polyether polyols usable with preference are obtainable by known methods, for example by anionic polymerization of alkylene oxides in the presence of alkali metal hydroxides, alkali metal alkoxides or amines as catalysts and by addition of at least one starter molecule, which preferably contains 2 or 3 reactive hydrogen atoms in bonded form, or by cationic polymerization of alkylene oxides in the presence of Lewis acids such as, for example, antimony pentachloride or boron trifluoride etherate, or by double metal cyanide catalysis. Suitable alkylene oxides contain from 2 to 4 carbon atoms in the alkylene radical. Examples are tetrahydrofuran, 1,3-propylene oxide, 1,2-propylene oxide, 1,2-butylene oxide and 2,3-butylene oxide; ethylene oxide and 1,2-propylene oxide are preferably used. The alkylene oxides can be used individually, cumulatively, in blocks, in alternation or as mixtures. Starter molecules used may especially be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule depends on the particular field of use of the resulting polyether polyol in the polyurethane production (for example, polyols used for production of flexible PU foams are different from those used in the production of rigid PU foams).

Polyester polyols usable with preference are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having 2 to 12, more preferably having 2 to 6, carbon atoms, preferably trimethylolpropane and glycerol.

Polyether polycarbonate polyols usable with preference are polyols containing carbon dioxide bound in the form of carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO₂ as co-monomer is very advantageously in environmental terms, since this reaction constitutes the conversion of a greenhouse gas to a polymer. The preparation of polyether polycarbonate polyols by addition of alkylene oxides and carbon dioxide onto H-functional starter substances by use of catalysts is well known. Various catalyst systems can be used here: The first generation was that of heterogeneous zinc or aluminium salts, as described, for example, in U.S. Pat. No. 3,900,424 or U.S. Pat. No. 3,953,383. In addition, mono- and binuclear metal complexes have been used successfully for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

Polyols usable with preference that are based on renewable raw materials, natural oil-based polyols (NOPs), for production of PU foams are of increasing interest with regard to the long-term limits in the availability of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now available on the market from various manufacturers (WO 2004/020497, US 2006/0229375, WO 2009/058367). Depending on the base raw material (e.g. soya bean oil, palm oil or castor oil) and the subsequent workup, polyols with different properties are obtained. It is possible here to distinguish essentially between two groups: a) polyols based on renewable raw materials which are modified such that they can be used to an extent of 100% for production of polyurethanes (WO 2004/020497, US 2006/0229375); b) polyols based on renewable raw materials which, because of the processing and properties thereof, can replace the petrochemical-based polyol only in a certain proportion (WO 2009/058367).

A further class of polyols usable with preference are the so-called filled polyols (polymer polyols). A key characteristic of these polyols is that they contain dispersed solid organic fillers up to a solids content of 40% or more. There are different types of polymer polyols available: SAN, PUD and PIPA polyols. SAN polyols are highly reactive polyols containing a dispersed copolymer based on styrene-acrylonitrile (SAN). PUD (poly-urea-dispersion) polyols are highly reactive polyols containing polyurea, likewise in dispersed form. PIPA (poly isocyanate poly addition) polyols are highly reactive polyols containing a dispersed polyurethane, for example formed by in situ reaction of an isocyanate with an alkanolamine in a conventional polyol.

Depending on the application the preferred solid content is typically between 5% and 40% based on the polyol. The solid content of the polymer polyols is supporting improved cell opening, which results in a more controlled foaming process, especially when TDI is used, so that no shrinkage of the foams occurs. The solids content thus acts as an essential processing aid. A further function is to control the foam hardness via the solids content in the foam formulation, since higher solid contents result in higher foam hardness. The formulations with solids-containing polyols are distinctly less self-stable and therefore tend to require additional physical stabilization to the chemical stabilization coming from the crosslinking reaction. Depending on the solid contents of the polyols, they can be used alone or in a blend with the abovementioned unfilled polyols.

A further class of polyols usable with preference is of those that are obtained as prepolymers via reaction of polyol with isocyanate in a molar ratio of 100:1 to 5:1, preferably 50:1 to 10:1. Such prepolymers are preferably made up in the form of a solution in polymer, and the polyol preferably corresponds to the polyol used for preparing the prepolymers.

A further class of polyols usable with preference is that of the so-called autocatalytic polyols, especially autocatalytic polyether polyols. Polyols of this kind are based, for example, on polyether blocks, preferably on ethylene oxide and/or propylene oxide blocks, and additionally include catalytically active functional groups, for example nitrogen-containing functional groups, especially amino groups, preferably tertiary amine functions, urea groups and/or heterocycles containing nitrogen atoms. Through the use of such autocatalytic polyols in the production of PU foams, preferably flexible PU foams, it is possible to reduce the required catalyst amount used in addition, depending on application, and/or to match it to specific desired foam properties. Suitable polyols are described, for example, in WO 0158976 (A1), WO 2005063841 (A1), WO 0222702 (A1), WO 2006055396 (A1), WO03029320 (A1), WO0158976 (A1), U.S. Pat. No. 6,924,321 (B2), U.S. Pat. No. 6,762,274 (B2), EP 2104696 (B1), WO 2004060956 (A1) or WO 2013102053 (A1) and can be purchased, for example, under the Voractiv™ and/or SpecFlex™ Activ trade names from Dow.

Depending on the required properties of the resulting foams, it is advantageously possible to use appropriate polyols, as described for example in: US 2007/0072951 A1, WO 2007/111828, US 2007/0238800, U.S. Pat. No. 6,359,022 or WO 96/12759. Further polyols are known to those skilled in the art and can be found, for example, in EP-A-0380993 or U.S. Pat. No. 3,346,557, to which reference is made in full.

The previous description was about the optional polyols. The recycled polyols are described later.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 10 to 1000, preferably 40 to 350, more preferably 70 to 140. An index of 100 represents a molar reactive group ratio of 1:1.

Catalysts used in the context of this invention may, for example, be any catalysts for the isocyanate-polyol (urethane formation) and/or isocyanate-water (amine and carbon dioxide formation) and/or isocyanate dimerization (uretdione formation), isocyanate trimerization (isocyanurate formation), isocyanate-isocyanate with CO₂ elimination (carbodiimide formation) and/or isocyanate-amine (urea formation) reactions and/or “secondary” crosslinking reactions such as isocyanate-urethane (allophanate formation) and/or isocyanate-urea (biuret formation) and/or isocyanate-carbodiimide (uretonimine formation).

Suitable catalysts for the purposes of the present invention are, for example, substances which catalyse one of the aforementioned reactions, especially the gelling reaction (isocyanate-polyol), the blowing reaction (isocyanate-water) and/or the dimerization or trimerization of the isocyanate. Such catalysts are preferably nitrogen compounds, especially amines and ammonium salts, and/or metal compounds.

Suitable nitrogen compounds as catalysts, also referred to hereinafter as nitrogen-containing catalysts, for the purposes of the present invention are all nitrogen compounds according to the prior art which catalyse one of the abovementioned isocyanate reactions and/or can be used for production of polyurethanes, especially of polyurethane foams.

Examples of suitable nitrogen-containing compounds as catalysts for the purposes of the present invention are preferably amines, especially tertiary amines or compounds containing one or more tertiary amine groups, including the amines triethylamine, N,N-dimethylcyclohexylamine, N,N-dicyclohexylmethylamine, N,N-dimethyl-aminoethylamine, N,N,N′,N′-tetramethylethylene-1,2-diamine, N,N,N′,N′-tetramethylpropylene-1,3-diamine, N,N,N′,N′-tetramethyl-1,4-butanediamine, N,N,N′,N′-tetramethyl-1,6-hexanediamine, N,N,N′,N″,N″-penta-methyldiethylenetriamine, N,N,N′-trimethylaminoethylethanolamine, N,N-dimethylaminopropylamine, N,N-diethylaminopropylamine, N,N-dimethylaminopropyl-N′,N′-dipropan-2-olamine, 2-[[3-(dimethylamino)propyl]-methylamino]ethanol, 3-(2-dimethylamino)ethoxypropylamine, N,N-bis[3-(dimethylamino)propyl]amine, N,N,N′,N″,N″-pentamethyldipropylenetriamine, 1-[bis[3-(dimethylamino)propyl]amino]-2-propanol, N,N-bis[3-(dimethylamino)propyl]-N′,N′-dimethylpropane-1,3-diamine, triethylenediamine, 1,4-diazabicyclo[2.2.2]octane-2-methanol, N,N′-dimethylpiperazine, 1,2-dimethylimidazole, N-(2-hydroxypropyl)imidazole, 1-isobutyl-2-methylimidazole, N-(3-aminopropyl)imidazole, N-methylimidazole, N-ethylmorpholine, N-methylmorpholine, 2,2,4-trimethyl-2-silamorpholine, N-ethyl-2,2-dimethyl-2-silamorpholine, N-(2-aminoethyl)morpholine, N-(2-hydroxyethyl)morpholine, bis(2-morpholinoethyl) ether, N,N′-dimethylpiperazine, N-(2-hydroxyethyl)piperazine, N-(2-aminoethyl)piperazine, N,N-dimethylbenzylamine, N,N-dimethylaminoethanol, N,N-diethylaminoethanol, 3-dimethylamino-1-propanol, N,N-dimethylaminoethoxyethanol, N,N-diethylaminoethoxyethanol, bis(2-dimethylaminoethyl) ether, N,N,N′-trimethyl-N′-(2-hydroxyethyl)bis(2-aminoethyl) ether, N,N,N′-trimethyl-N-3′-aminopropyl bisaminoethyl ether, tris(dimethylaminopropyl)hexahydro-1,3,5-triazine, 1,8-diazabicyclo[5.4.0]undec-7-ene, 1,5-diazabicyclo[4.3.0]non-5-ene, 1,5,7-triazabicyclo[4.4.0]dec-5-ene, N-methyl-1,5,7-triazabicyclo[4.4.0]dec-5-ene, 1,4,6-triazabicyclo[3.3.0]oct-4-ene, 1,1,3,3-tetramethylguanidine, tert-butyl-1,1,3,3-tetramethylguanidine, guanidine, 3-dimethylaminopropylurea, 1,3-bis[3-(dimethylamino)propyl]urea, bis-N,N-(dimethylaminoethoxyethyl)isophorone dicarbamate, 3-dimethylamino-N,N-dimethylpropionamide and 2,4,6-tris(dimethylaminomethyl)phenol. Suitable nitrogen-containing catalysts according to the prior art can be purchased, for example, from Evonik under the DABCO® trade name.

According to the application, it may be preferable that, in the inventive production of polyurethane foams, quaternized and/or protonated nitrogen-containing catalysts, especially quaternized and/or protonated tertiary amines, are used.

For possible quaternization of nitrogen-containing catalysts, it is possible to use any reagents known as quaternizing reagents. Preference is given to using alkylating agents such as dimethyl sulfate, methyl chloride or benzyl chloride, preferably methylating agents such as, in particular, dimethyl sulfate, as quaternizing agents.

Quaternization can likewise be carried out using alkylene oxides, such as ethylene oxide, propylene oxide or butylene oxide, preferably with subsequent neutralization using inorganic or organic acids.

Nitrogen-containing catalysts, if quaternized, may be singly or multiply quaternized. Preferably, the nitrogen-containing catalysts are only singly quaternized. In the case of single quaternization, the nitrogen-containing catalysts are preferably quaternized on a tertiary nitrogen atom.

Nitrogen-containing catalysts can be converted to the corresponding protonated compounds by reaction with organic or inorganic acids. These protonated compounds may be preferable, for example, when a slower polyurethane reaction is to be achieved or when the reaction mixture is to have enhanced flow behaviour in use.

Organic acids used may, for example, be any organic acids mentioned below, for example carboxylic acids having from 1 to 36 carbon atoms (aromatic or aliphatic, linear or branched), for example formic acid, lactic acid, 2-ethylhexanoic acid, salicylic acid and neodecanoic acid, or else polymeric acids such as polyacrylic or polymethacrylic acids. Inorganic acids used may, for example, be phosphorus-based acids, sulfur-based acids or boron-based acids.

However, the use of nitrogen-containing catalysts which have not been quaternized or protonated is particularly preferred in the context of this invention.

Suitable metal compounds as catalysts, also referred to hereinafter as metallic catalysts, for the purposes of the present invention are all metal compounds according to the prior art which catalyse one of the abovementioned isocyanate reactions and/or can be used for production of polyurethanes, especially of polyurethane foams. They may be selected, for example, from the group of the metal-organic or organometallic compounds, metal-organic or organometallic salts, organic metal salts, inorganic metal salts, and from the group of the charged or uncharged metallic coordination compounds, especially the metal chelate complexes.

The expression “metal-organic or organometallic compounds” in the context of this invention especially encompasses the use of metal compounds having a direct carbon-metal bond, also referred to here as metal organyls (e.g. tin organyls) or organometallic compounds (e.g. organotin compounds). The expression “organometallic or metal-organic salts” in the context of this invention especially encompasses the use of metal-organic or organometallic compounds having salt character, i.e. ionic compounds in which either the anion or cation is organometallic in nature (e.g. organotin oxides, organotin chlorides or organotin carboxylates). The expression “organic metal salts” in the context of this invention especially encompasses the use of metal compounds which do not have any direct carbon-metal bond and are simultaneously metal salts, in which either the anion or the cation is an organic compound (e.g. tin(II) carboxylates). The expression “inorganic metal salts” in the context of this invention especially encompasses the use of metal compounds or of metal salts in which neither the anion nor the cation is an organic compound, e.g. metal chlorides (e.g. tin(II) chloride), pure metal oxides (e.g. tin oxides) or mixed metal oxides, i.e. containing a plurality of metals, and/or metal silicates or aluminosilicates. The expression “coordination compound” in the context of this invention especially encompasses the use of metal compounds formed from one or more central particles and one or more ligands, the central particles being charged or uncharged metals (e.g. metal- or tin-amine complexes). For the purposes of the present invention, the expression “metal-chelate complexes” encompasses especially the use of metal-containing coordination compounds which have ligands having at least two coordination or bonding positions to the metal centre (e.g. metal- or tin-polyamine or metal- or tin-polyether complexes).

Suitable metal compounds, especially as defined above, as possible catalysts in the context of the present invention may be selected, for example, from all metal compounds containing lithium, sodium, potassium, magnesium, calcium, scandium, yttrium, titanium, zirconium, vanadium, niobium, chromium, molybdenum, tungsten, manganese, cobalt, nickel, copper, zinc, mercury, aluminium, gallium, indium, germanium, tin, lead, and/or bismuth, especially sodium, potassium, magnesium, calcium, titanium, zirconium, molybdenum, tungsten, zinc, aluminium, tin and/or bismuth, more preferably tin, bismuth, zinc and/or potassium.

Suitable organometallic salts and organic metal salts, especially as defined above, as catalysts in the context of the present invention are, for example, organotin, tin, zinc, bismuth and potassium salts, in particular corresponding metal carboxylates, alkoxides, thiolates and mercaptoacetates, for example dibutyltin diacetate, dimethyltin dilaurate, dibutyltin dilaurate (DBTDL), dioctyltin dilaurate (DOTDL), dimethyltin dineodecanoate, dibutyltin dineodecanoate, dioctyltin dineodecanoate, dibutyltin dioleate, dibutyltin bis(n-lauryl mercaptide), dimethyltin bis(n-lauryl mercaptide), monomethyltin tris(2-ethylhexyl mercaptoacetate), dimethyltin bis(2-ethylhexyl mercaptoacetate), dibutyltin bis(2-ethylhexyl mercaptoacetate), dioctyltin bis(isooctyl mercaptoacetate), tin(II) acetate, tin(II) 2-ethylhexanoate (tin(II) octoate), tin(II) isononanoate (tin(II) 3,5,5-trimethylhexanoate), tin(II) neodecanoate, tin(II) ricinoleate, tin(II) oleate, zinc(II) acetate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, bismuth acetate, bismuth 2-ethylhexanoate, bismuth octoate, bismuth isononanoate, bismuth neodecanoate, potassium formate, potassium acetate, potassium 2-ethylhexanoate (potassium octoate), potassium isononanoate, potassium neodecanoate and/or potassium ricinoleate.

In the inventive production of polyurethane foams, it may be preferable to rule out the use of organometallic salts, for example of dibutyltin dilaurate.

Suitable possible metallic catalysts are preferably selected such that they do not have any troublesome intrinsic odour and are essentially toxicologically safe, and such that the resulting polyurethane systems, especially polyurethane foams, preferably have a minimum level of catalyst-related emissions.

In the inventive production of polyurethane foams, it may be preferable, according to the type of application, to use incorporable/reactive or high molecular weight catalysts. Preferred catalysts of this kind may be selected, for example, from the group of the metal compounds, preferably from the group of the tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, and/or from the group of the nitrogen compounds, especially from the group of the low-emission amines and/or the low-emission compounds containing one or more tertiary amine groups, for example described by the amines dimethylaminoethanol, N,N-dimethyl-N′,N′-di(2-hydroxypropyl)-1,3-diaminopropane, N,N-dimethylaminopropylamine, N,N,N′-trimethyl-N′-hydroxyethylbis(aminoethyl)ether, N-[2-[2-(dimethylamino)ethoxy]ethyl]-N-methylpropane-1,3-diamine, N,N-bis[3-(dimethylamino)propyl]propane-1,3-diamine, 1,1′-[(3-{bis[3-(dimethylamino)propyl]-amino}propyl)imino]dipropan-2-ol, bis(N,N-dimethylaminopropyl)amine, 6-dimethylaminoethyl-1-hexanol, N-(2-hydroxypropyl)imidazole, N-(3-aminopropyl)imidazole, aminopropyl-2-methylimidazole, N,N,N′-trimethylaminoethanolamine, 2-(2-(N,N-dimethylaminoethoxy)ethanol, N-(dimethyl-3-aminopropyl)urea derivatives and alkylaminooxamides, such as bis(N—(N′,N-dimethylaminopropyl))oxamide, bis(N—(N′,N-dimethylaminoethyl))oxamide, bis(N—(N′,N′-imidazol-idinylpropyl)oxamide, bis(N—(N′,N′-diethylaminoethyl))oxamide, bis(N—(N′,N′-diethylaminopropyl)oxamide, bis(N—(N′,N′-diethylaminoethyl)oxamide, bis(N—(N′,N′-diethylimino-1-methylpropyl)oxamide, bis(N-(3-morpholino-propylyl)oxamide, and the reaction products thereof with alkylene oxides, preferably having a molar mass in the range between 160 and 500 g/mol.

A preferred inventive process is characterized in that the one or more catalysts (c) are selected from the group of nitrogen-containing compounds preferably amines, especially tertiary amines or compounds containing one or more tertiary amine groups, including triethylenediamine, 1,4-diazabicyclo[2.2.2]octane-2-methanol, diethanolamine and compounds of the general formula (1)

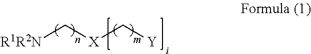

with
X represents oxygen, nitrogen, hydroxyl, amines (NR³ or NR³R⁴) or urea (N(R⁵)C(O)N(R⁶) or N(R⁵)C(O)NR⁶R⁷)
Y represents amine NR⁸R⁹ or ether OR⁹
R^{1,2} represent identical or different aliphatic or aromatic linear or cyclic hydrocarbon radicals having 1-8 carbon atoms optionally bearing an OH-group or representing hydrogen
R³⁻⁹ represent identical or different aliphatic or aromatic linear or cyclic hydrocarbon radicals having 1-8 carbon atoms optionally bearing an OH or a NH or NH₂ group or representing hydrogen.
m=0 to 4, preferably 2 or 3
n=2 to 6, preferable 2 or 3
i=0 to 3, preferably 0-2
preferably with the proviso that at least one of the groups X, Y or R¹⁻⁹ bears a functionality reactive with the polyurethane matrix, preferably an isocyanate-reactive functionality, especially preferably NH or NH₂ or OH.

If one or more catalysts (c) are selected from the group of the low-emission amines and/or the low-emission compounds containing one or more tertiary amine groups preferably having a molar mass in the range between 160 and 500 g/mol and/or bearing a functionality reactive with the polyurethane matrix, preferably an isocyanate-reactive functionality, especially preferably NH or NH₂ or OH, then that corresponds to a preferred embodiment of the invention.

If one or more catalysts (c) are selected from the group of the metal-organic or organometallic compounds, metal-organic or organometallic salts, organic metal salts, inorganic metal salts, and from the group of the charged or uncharged metallic coordination compounds, especially the metal chelate complexes, more preferably selected from the group of incorporable/reactive or high molecular weight metal catalysts, further preferred selected from the group tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, then that corresponds to a preferred embodiment of the invention.

Such catalysts and/or mixtures are supplied commercially, for example, under the following names: Jeffcat® ZF-10, Lupragen® DMEA, Lupragen® API, Toyocat® RX 20 and Toyocat® RX 21, DABCO® RP 202, DABCO® RP 204, DABCO® NE 300, DABCO® NE 310, DABCO® NE 400, DABCO® NE 500, DABCO® NE 600, DABCO® NE 650, DABCO® NE 660, DABCO® NE 740, DABCO® NE 750, DABCO® NE 1060, DABCO® NE 1080, DABCO® NE 1082 and DABCO® NE 2039, DABCO® NE 1050, DABCO® NE 1070, DABCO® NE 1065; DABCO® T, POLYCAT® 15; Niax® EF 860, Niax® EF 890, Niax® EF 700, Niax® EF 705, Niax® EF 708, Niax® EF 600, Niax® EF 602, Kosmos® 54, Kosmos® EF, and Tegoamin® ZE 1.

According to the application, it may be preferable that, in the inventive production of polyurethane foams, one or more nitrogen-containing and/or metallic catalysts are used. When more than one catalyst is used, the catalysts may be used in any desired mixtures with one another. It is possible here to use the catalysts individually during the foaming operation, for example in the manner of a preliminary dosage in the mixing head, and/or in the form of a premixed catalyst combination.

The expression “premixed catalyst combination”, also referred to hereinafter as catalyst combination, for the purposes of this invention especially encompasses ready-made mixtures of metallic catalysts and/or nitrogenous catalysts and/or corresponding protonated and/or quaternized nitrogenous catalysts, and optionally also further ingredients or additives, for example water, organic solvents, acids for blocking the amines, emulsifiers, surfactants, blowing agents, antioxidants, flame retardants, stabilizers and/or siloxanes, preferably polyether siloxanes, which are already present as such prior to the foaming and need not be added as individual components during the foaming operation.

According to the application, it may be preferable when the sum total of all the nitrogen-containing catalysts used relative to the sum total of the metallic catalysts, especially potassium, zinc and/or tin catalysts, results in a molar ratio of 1:0.05 to 0.05:1, preferably 1:0.07 to 0.07:1 and more preferably 1:0.1 to 0.1:1.

In order to prevent any reaction of the components with one another, especially reaction of nitrogen-containing catalysts with metallic catalysts, especially potassium, zinc and/or tin catalysts, it may be preferable to store these components separately from one another and then to feed in the isocyanate and polyol reaction mixture simultaneously or successively.

Suitable use amounts of catalysts are guided by the type of catalyst and are preferably in the range from 0.005 to 10.0 pphp, more preferably in the range from 0.01 to 5.00 pphp (=parts by weight based on 100 parts by weight of polyol) or 0.10 to 10.0 pphp for potassium salts.

Preferred water contents in the process according to the invention depend on whether or not physical blowing agents are used in addition to water, the use of which is optional. In the case of purely water-blown foams, the values typically range from preferably 1 to 20 pphp; when other blowing agents are used in addition, the amount of water used typically decreases to e.g. 0 or to the range from e.g. 0.1 to 5 pphp. To achieve high foam densities, preferably neither water nor any other blowing agent is used.

Suitable, optionally usable physical blowing agents for the purposes of this invention are gases, for example liquefied CO₂, and volatile liquids, for example hydrocarbons of 4 or 5 carbon atoms, preferably cyclo-, iso- and n-pentane, hydrofluorocarbons, preferably HFC 245fa, HFC 134a and HFC 365mfc, but also olefinic hydrofluorocarbons such as HFO 1233zd or HFO1336mzzZ, hydrochlorofluorocarbons, preferably HCFC 141 b, oxygen-containing compounds such as methyl formate and dimethoxymethane, or hydrochlorocarbons, preferably dichloromethane and 1,2-dichloroethane. Suitable blowing agents further include ketones (e.g. acetone) or aldehydes (e.g. methylal).

In addition to or in place of any water and any physical blowing agents, it is also possible to use other chemical blowing agents that react with isocyanates with gas evolution, examples being formic acid, carbamates or carbonates.

Suitable stabilizers against oxidative degradation, known as antioxidants, preferably include all common free-radical scavengers, peroxide scavengers, UV absorbers, light stabilizers, complexing agents for metal ion impurities (metal deactivators).

Suitable flame retardants in the context of this invention are all substances which are regarded as suitable for this purpose according to the prior art. Preferred flame retardants are, for example, liquid organophosphorus compounds such as halogen-free organophosphates, e.g. triethyl phosphate (TEP), halogenated phosphates, for example tris(1-chloro-2-propyl) phosphate (TCPP), tris(1,3-dichloro-2-propyl) phosphate (TDCPP) and tris(2-chloroethyl) phosphate (TCEP), and organic phosphonates, for example dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine.

Biocides used may, for example, be commercial products such as chlorophene, benzisothiazolinone, hexahydro-1,3,5-tris(hydroxyethyl-s-triazine), chloromethylisothiazolinone, methylisothiazolinone or 1,6-dihydroxy-2,5-dioxohexane, which are known by the trade names BIT 10, Nipacide BCP, Acticide MBS, Nipacide BK, Nipacide Cl, Nipacide FC.

For stabilization of the rising foam mixture and for influencing the foam properties of polyurethane foams, organomodified siloxanes are preferably used in the production of the different types of PU foams. (Organomodified) siloxanes suitable for this purpose are described for example in the following documents: EP 0839852, EP 1544235, DE 102004001408, EP 0839852, WO 2005/118668, US 20070072951, DE 2533074, EP 1537159, EP 533202, U.S. Pat. No. 3,933,695, EP 0780414, DE 4239054, DE 4229402, EP 867465.

These compounds may be prepared as described in the prior art. Suitable examples are described, for instance, in U.S. Pat. No. 4,147,847, EP 0493836, U.S. Pat. No. 4,855,379, EP 1520870, EP 0600261, EP 0585771, EP 0415208 and U.S. Pat. No. 3,532,732.

Preference is given to foam stabilizers, those based on polydialkylsiloxane-polyoxyalkylene copolymers, as generally used in the production of urethane foams. Preferred foam stabilizers for the production of hot-cure flexible PU foams are characterized by large siloxane structures preferably having more than 50 Si units and pendant polyethers. These preferred foam stabilizers are also referred to as polydialkylsiloxane-polyoxyalkylene copolymers. The structure of these compounds is preferably such that, for example, a long-chain copolymer of ethylene oxide and propylene oxide is bonded to a polydimethylsiloxane radical. The linkage between the polydialkylsiloxane and the polyether moiety may be via SiC or Si—O—C linkage. In a preferred embodiment, the polyether moieties are built up from the monomers propylene oxide, ethylene oxide, butylene oxide and/or styrene oxide in blocks or in random distribution, and may either be hydroxy-functional or end-capped by a methyl ether function or an acetoxy function. The molecular masses of the polyether moieties preferably are in a range of 150 to 8000 g/mol. In structural terms, the polyether or the different polyethers may be bonded to the polydialkylsiloxane in terminal or lateral positions. The alkyl radical of the siloxane may be aliphatic, cycloaliphatic or aromatic. Methyl groups are very particularly advantageous. The organomodified polydialkylsiloxane may be linear or else contain branches. Suitable stabilizers, especially foam stabilizers, are described inter alia in U.S. Pat. Nos. 2,834,748, 2,917,480 and in U.S. Pat. No. 3,629,308. The function of the foam stabilizer is to assure the stability of the foaming reaction mixture. The contribution to foam stabilization correlates here with siloxane chain length. Without foam stabilizer, a collapse is observed, and hence no homogeneous foam is obtained. In the case of some flexible PU foam types, that have higher stability and hence a lower tendency to collapse, it is also possible to use low molecular weight polyether siloxanes. These then have siloxane chain lengths much shorter than 50. For instance, in the case of cold-cure flexible PU foams or ester foams, unmodified or modified short-chain siloxanes are preferably used. When long-chain and hence more potent siloxane stabilizers are used, by contrast, over-stabilization and hence shrinkage after foam production is observed in such foam types.

Suitable stabilizers can be purchased from Evonik Industries under the TEGOSTAB® trade name.

Especially preferred siloxanes that may be used according to a preferred embodiment of the invention have the following structure:

[R^{I}₂R^{II}SiO_{1/2}]ₐ[R^{I}₃SiO_{1/2}]_{b}[R^{I}₂SiO_{2/2}]_{c}[R^{I}R^{II}SiO_{2/2}]_{d}[R^{III}SiO_{3/2}]ₑ[SiO_{4/2}]_{f}G_{g} Formula (2):
with
   a=0 to 12, preferably 0 to 10, more preferably 0 to 8
   b=0 to 8, preferably 0 to 6, more preferably 0 to 2
   c=0 to 250, preferably 1 to 200, more preferably 1.5 to 150
   d=0 to 40, preferably 0 to 30, more preferably 0 to 20
   e=0 to 10, preferably 0 to 8, more preferably 0 to 6
   f=0 to 5, preferably 0 to 3, more preferably 0
   g=0 to 3, preferably 0 to 2.5, more preferably 0 to 2
   where:

$$\begin{matrix}a + b + c + d + e + f + g > 3 \\ a + b \geq 2\end{matrix}$$

G=independently same or different radicals selected from the group of
   (O_{1/2})ₙSiR^{I}ₘ—CH₂CHR^{V}—R^{IV}—CHR^{V}CH₂—SiR^{I}ₘ(O_{1/2})ₙ
   (O_{1/2})ₙSiR^{I}ₘ—CH₂CHR^{V}—R^{IV}—CR^{V}═CH₂
   (O_{1/2})ₙSiR^{I}ₘ—CH₂CHR^{V}—R^{IV}—CR^{V}═CR^{V}—CH₃
   R^{IV}=independently same or different divalent organic radicals, preferably same or different divalent organic radicals having 1-50 carbon atoms, optionally interrupted by ether-, ester- or amide-groups and optionally bearing OH functions or (—SiR^{I}₂O—)ₓSiR^{I}₂-groups, more preferably same or different divalent organic radicals having 2-30 carbon atoms, optionally interrupted by ether, ester or amide-groups and optionally bearing OH functions, or (—SiR^{I}₂O—)ₓSiR^{I}₂ groups
   x=1 to 50, preferably 1 to 25, more preferably 1 to 10
   R^{V}=independently same or different radicals, selected from the group of alkyl radicals having 1-16 carbon atoms or aryl radicals having 6-16 carbon atoms or hydrogen, preferably selected from the group of alkyl radicals having 1-6 carbon atoms or aryl radicals having 6-10 carbon atoms or hydrogen, more preferably methyl or hydrogen
   where:
   n=1 or 2
   m=1 or 2
   n+m=3
   R^{I}=same or different radicals, selected from the group of alkyl radicals having 1-16 carbon atoms or aryl radicals having 6-16 carbon atoms or hydrogen or —OR^{VI}, saturated or unsaturated, preferably methyl, ethyl, octyl, dodecyl, phenyl or hydrogen, more preferably methyl or phenyl.
   R^{II}=independently identical or different polyethers obtainable from the polymerization of ethylene oxide, propylene oxide and/or other alkylene oxides such as butylene oxide or styrene oxide of the general formula (3) or an organic radical according to formula (4)

(R^{VI})ₕ—O—[C₂H₄O]ᵢ—[C₃H₆O]ⱼ—[CR^{VIII}₂CR^{VIII}₂O]ₖ—R^{IX} Formula (3)

Oₕ—R^{X} Formula (4)
Where
   h=0 or 1
   R^{VII}=divalent organic radical, preferably a divalent organic alkyl or aryl radical, optionally substituted with —OR^{VI} or a divalent organic radical of type CₚH₂ₚ, more preferably a divalent organic radical of type CₚH₂ₚ
   i=0 to 150, preferably 1 to 100, more preferably 1 to 80
   j=0 to 150, preferably 0 to 100, more preferably 0 to 80
   k=0 to 80, preferably 0 to 40, more preferably 0
   p=1-18, preferably 1-10, more preferably 3 or 4
   where

$$i + j + k \geq 3$$

R^{III}=same or different radicals, selected from the group of alkyl or aryl radicals, saturated or unsaturated, unsubstituted or substituted with hetero atoms, preferably alkyl radicals having 1-16 carbon atoms or aryl radicals having 6-16 atoms, saturated or unsaturated, unsubstituted or substituted with halogen atoms, more preferably methyl, vinyl, chlorpropyl or phenyl.
   R^{VI}=same or different radicals, selected from the group of alkyl radicals having 1-16 carbon atoms or aryl radicals having 6-16 carbon atoms, saturated or unsaturated, or hydrogen, preferably alkyl radicals having 1-8 carbon atoms, saturated or unsaturated, or hydrogen, more preferably methyl, ethyl, isopropyl or hydrogen.
   R^{VIII}=same or different radicals, selected from the group of alkyl radicals having 1-18 carbon atoms and optionally bearing ether functions or substitution with hetero atoms like halogen atoms, or aryl radicals having 6-18 carbon atoms and optionally bearing ether functions, or hydrogen, preferably alkyl radicals having 1-12 carbon atoms, and optionally bearing ether functions or substitution with halogen atoms, or aryl radicals having 6-12 carbon atoms and optionally bearing ether functions, or hydrogen, more preferably hydrogen, methyl, ethyl or benzyl.
   R^{IX}=same or different radicals, selected from the group of hydrogen, alkyl, —C(O)—R^{XI}, —C(O)O—R^{XI} or —C(O)NHR^{XI}, saturated or unsaturated, optionally substituted with hetero atoms, preferably hydrogen, alkyl having 1-8 carbon atoms or acetyl, more preferably H, methyl, acetyl or butyl.
   R^{X}=same or different radicals, selected from the group of alkyl radicals or aryl radicals, saturated or unsaturated, and optionally bearing one or more OH, ether, epoxide, ester, amine or/and halogen substituents, preferably alkyl radicals having 1-18 carbon atoms or aryl radicals having 6-18 carbon atoms, saturated or unsaturated, and optionally bearing one or more OH, ether, epoxide, ester, amine or/and halogen substituents, more preferably alkyl radicals having 1-18 carbon atoms or aryl radicals having 6-18 carbon atoms, saturated or unsaturated, bearing at least one substituent selected of the group of OH, ether, epoxide, ester, amine or/and halogen substituents.
   R^{XI}=same or different radicals, selected from the group of alkyl radicals having 1-16 carbon atoms or aryl radicals having 6-16 carbon atoms, saturated or unsaturated, preferably saturated or unsaturated alkyl radicals having 1-8 carbon atoms or aryl radicals having 6-16 carbon atoms, more preferably methyl, ethyl, butyl or phenyl.

The siloxanes of the formula (2) can be prepared by known methods, for example the noble metal-catalysed hydrosilylation reaction of compounds containing a double bond with corresponding hydrosiloxanes, as described, for example, in EP 1520870. The document EP 1520870 is hereby incorporated by reference and is considered to form part of the disclosure-content of the present invention.

In a preferred embodiment of the invention, siloxanes of formula (2) contain a low amount of cyclic siloxanes, which means that the total content of the sum of cyclotetrasiloxane (D4), cyclopentasiloxane (D5) and cyclohexasiloxane (D6) is not higher than 0.1% by weight. In a particularly preferred embodiment of the invention, the total content of D4, D5 and D6 is not higher than 0.07% by weight. It is also possible to use the siloxanes of formula (2) as blends with e.g. suitable solvents and/or further additives.

Compounds of formula (2) can be used alone or as mixtures with different compounds of formula (2) together with suitable solvents and/or further additives. As optional solvents, it is possible to employ all suitable substances known from the prior art. Depending on the application, it is possible to use aprotic nonpolar, aprotic polar and protic solvents. Suitable aprotic nonpolar solvents can, for example, be selected from the following classes of substances, or classes of substances containing the following functional groups: aromatic hydrocarbons, aliphatic hydrocarbons (alkanes (paraffins) and olefins), carboxylic esters (e.g. isopropyl myristate, propylene glycol dioleate, decyl cocoate or other esters of fatty acids) and polyesters, (poly)ethers and/or halogenated hydrocarbons having a low polarity. Suitable aprotic polar solvents can, for example, be selected from the following classes of substances, or classes of substances containing the following functional groups: ketones, lactones, lactams, nitriles, carboxamides, sulfoxides and/or sulfones. Suitable protic solvents can, for example, be selected from the following classes of substances, or classes of substances containing the following functional groups: alcohols, polyols, (poly)alkylene glycols, amines, carboxylic acids, in particular fatty acids and/or primary and secondary amides. Particular preference is given to solvents which are readily employable in the foaming operation and do not adversely affect the properties of the foam. For example, isocyanate-reactive compounds are suitable, since they are incorporated into the polymer matrix by reaction and do not generate any emissions of the foam. Examples are OH-functional compounds such as (poly)alkylene glycols, preferably monoethylene glycol (MEG or EG), diethylene glycol (DEG), triethylene glycol (TEG), 1,2-propylene glycol (PG), dipropylene glycol (DPG), trimethylene glycol (propane-1,3-diol, PDO), tetramethylene glycol (butanediol, BDO), butyl diglycol (BDG), neopentyl glycol, 2-methylpropane-1,3-diol (ORTEGOL® CXT) and higher homologues thereof, for example polyethylene glycol (PEG) having average molecular masses between 200 g/mol and 3000 g/mol. Particularly preferred OH-functional compounds further include polyethers having average molecular masses of 200 g/mol to 4500 g/mol, especially 400 g/mol to 2000 g/mol, among these preferably water-, allyl-, butyl- or nonyl-initiated polyethers, in particular those which are based on propylene oxide (PO) and/or ethylene oxide (EO) blocks.

The process according to the invention is performed in the presence of recycled polyol obtained by hydrolysis of a polyurethane, comprising contacting said polyurethane with water in the presence of a base-catalyst-combination (I) or (II).

The route to obtain the recycled polyol and the hydrolysis process of a polyurethane are described herein.

First, we refer to the recycled polyol which was obtained by hydrolysis of a polyurethane, comprising contacting said polyurethane with water in the presence of a base-catalyst-combination (I)
(I) comprises a base having a pK_{b} value at 25° C. of from 1 to 10, and a catalyst selected from the group consisting of quaternary ammonium salts containing an ammonium cation containing 6 to 30 carbon atoms and organic sulfonates containing at least 7 carbon atoms.

The bases used here have a pK_{b} value at 25° C. of from 1 to 10, preferably 1 to 8, more preferred 1 to 7 and most preferred 1.5 to 6. The base preferably comprises an alkali metal cation and/or an ammonium cation.

Organic bases, i.e. bases comprising one or more CH bonds, or inorganic base, i.e. bases that do not comprise CH bonds, can be used. Preferably low or non-corrosive bases are used. Particular preferred a base is used in the hydrolysis process selected from the group consisting of alkali metal phosphates, alkali metal hydrogen phosphates, alkali metal carbonates, alkali metal silicates. alkali metal hydrogen carbonates, alkali metal acetates, alkali metal sulfites, ammonium hydroxide, and mixtures thereof.

Ammonium cation in the base of the invention includes NH₄⁺, NHR₃⁺, NH₂R₂+, NH₃R⁺, for example ammonium hydroxide includes NH₄OH, NHR₃OH, NH₂R₂OH, NH₃ROH, wherein R stand for an organic residue and wherein the residues R in the ammonium cations may be identical or different. Preferably ammonium cation of the base stands for NH₄⁺. Particular preferred the base of the invention does not comprise alkaline earth metal cations.

Even more preferred a base is used selected from the group consisting of alkali metal phosphates, alkali metal carbonates, alkali metal silicates, ammonium hydroxide, and mixtures thereof.

Most preferred a base is used selected from the group consisting of alkali metal carbonates, alkali metal silicates. and mixtures thereof.

Preferred alkali metals are selected from the group consisting of Na, K and Li and mixtures thereof, most preferred Na and K and mixtures thereof.

Use of the bases described before allows to run the hydrolysis process in standard equipment, preferably in steel reactors, without special corrosion protection and thus, significantly contributes to a reduction of the invest costs for the plants. It is also possible to use very cheap bases that contribute to reduced operating costs.

The amount of base in the reaction mixture must be sufficient to catalyze the desired hydrolysis of the polyurethane at a practicable rate. Preferably the weight ratio base to polyurethane is in the range of from 0.01 to 50, more preferred 0.1 to 25 and most preferred 0.5 to 20. Preferably the base is used in form of a base solution comprising a base and water, even more preferred as a saturated base solution. If a saturated base solution is used it is preferred that the weight ratio of saturated base solution to polyurethane, calculated at 25° C., is in the range of from of 0.5 to 25, more preferred 0.5 to 15, even more preferred 1 to 10 and most preferred 2 to 7.

Quaternary ammonium salts, organic sulfonates, or some combination or mixture thereof are used as phase transfer catalysts in the hydrolysis process. Preferably quaternary ammonium salts are used.

Although the addition of even trace amounts of these catalysts will accelerate the hydrolysis rate, it is preferred that at least 0.5 weight percent catalyst based on the weight of the polyurethane are used, more preferably 0.5 to 15 weight percent, even more preferred 1 to 10 weight percent, particular preferred more 1 to 8 weight percent, especially preferred 1 to 7 and most preferred 2 to 6 weight percent.

The quaternary ammonium salts useful in the hydrolysis process include those organic nitrogen-containing compounds in which the molecular structure includes a central positively-charged nitrogen atom joined to four organic (i.e., hydrocarbyl) groups, i.e. the ammonium cation, and a negatively charged anion such as halide, preferably chloride, bromide, hydrogen sulfate, alkyl sulfate, preferably methylsulfate and ethylsulfate, carbonate, hydrogen carbonate, carboxylate, preferably acetate, or hydroxide.

Quaternary ammonium salts are well known and are described, for example, in Cahn et al., “Surfactants and Defensive Systems”, in Encyclopedia of Chemical Technology, Third Edition Vol. 22, pp. 383-385 (1983) and Catonic Surfactants, E. Jungermann, Ed., Marcel Dekker, New York (1970), pp. 1-173. Many such compounds are commercially available at relatively low cost.

Quaternary ammonium salts containing an ammonium cation containing a total of 6 to 30 carbon atoms have been found to be most effective in the hydrolysis process. In contrast to the teachings of U.S. Pat. No. 5,208,379, the inventors found out that yields significantly decrease if ammonium cation containing a total of more than 30 carbon atoms are used. The same is true if the number of carbon atoms is below 6.

Catalyst that have proven to be highly efficient and thus are preferably used in the hydrolysis process are quaternary ammonium salts having the general structure R₁ R₂ R₃ R₄ NX wherein R₁, R₂, R₃, and R₄ are the same or different and are hydrocarbyl groups selected from alkyl, aryl, and arylalkyl and X is selected from the group consisting of halide, preferably chloride and/or bromide, hydrogen sulfate, alkyl sulfate, preferably methylsulfate and ethylsulfate, carbonate, hydrogen carbonate, carboxylate, preferably acetate, or hydroxide.

Preferably
R₁ and R₂ are the same or different and are alkyl groups with 1 to 12, preferably 1 to 10, more preferred 1 to 7, even more preferred 1 to 6, especially preferred 1 to 5 and most preferred 1 to 4 carbon atoms, wherein the alkyl groups may be linear, branched, cyclic, saturated or unsaturated, most preferred are linear saturated alkyl groups,
R₃ is selected from the group consisting of alkyl groups with 1 to 12, preferably 1 to 10, more preferred 1 to 7, even more preferred 1 to 6, especially preferred 1 to 5 and most preferred 1 to 4 carbon atoms, aryl groups with 6 to 14, preferably 6 to 12, and most preferred 6 to 10 carbon atoms, and aralkyl groups with 7 to 14, preferably 7 to 12, and most preferred 7 to 10 carbon atoms, wherein the alkyl groups may be linear, branched, cyclic, saturated or unsaturated, most preferred linear and saturated,
R₄ is selected from the group consisting of alkyl groups with 3 to 12, preferably 3 to 10, more preferred 3 to 7, most preferred 4 to 6 carbon atoms, aryl groups with 6 to 14, preferably 6 to 12, and most preferred 6 to 10 carbon atoms, and aralkyl groups with 7 to 14, preferably 7 to 12, and most preferred 7 to 10 carbon atoms, wherein the alkyl groups may be linear, branched, cyclic, saturated or unsaturated, most preferred linear and saturated, and
X is selected from the group consisting of halide, preferably chloride and/or bromide, hydrogen sulfate, alkyl sulfate, preferably methylsulfate and ethylsulfate, carbonate, hydrogen carbonate, carboxylate, preferably acetate, or hydroxide.

In a first preferred embodiment the catalyst is a quaternary ammonium salt having the general structure R₁ R₂ R₃ R₄ NX wherein R₁ to R₄ and X are defined as described before and are selected such that the sum of carbon atoms of the ammonium cation is 6 to 14, preferably 7 to 14, more preferred 8 to 13. These catalysts have been found to be very efficient at reaction temperatures below or equal to 140° C.

In a second preferred embodiment the catalyst is a quaternary ammonium salt having the general structure R₁ R₂ R₃ R₄ NX wherein R₁ to R₄ and X are defined as described before and are selected such that the sum of carbon atoms of the ammonium cation is 15 to 30, preferably 15 to 28, more preferred 15 to 24, even more preferred 16 to 22 and most preferred 16 to 20. These catalysts can be used under a wide variety of temperatures but especially at temperatures above 140° C.

Most preferred quaternary ammonium salts appropriate for use as the activating agent in the hydrolysis process include tetrabutylammounium hydrogensulfate, benzyltrimethylammonium chloride, tributyl methyl ammonium chloride and Trioctyl methyl ammonium methyl sulphate.

The other class of activating agents useful in the practice of the hydrolysis process includes organic sulfonates (i.e., organic compounds containing at least one sulfonate functional group). Such substances have the general formula R—SO₃M, wherein R is a linear, branched, cyclic, saturated or unsaturated alkyl group, an aryl group, or alkyl aryl group containing at least 7 carbon atoms and M is alkali metal (e.g., sodium, potassium), alkaline earth metal (e.g., calcium, barium, magnesium), or ammonium (NH₄, NHR₃, NH₂R₂, NH₃R), where M may also be hydrogen, provided sufficient strong base is present during the hydrolysis reaction to convert the organic sulfonate into its salt (anionic) form and R is an organic moiety such as methyl or ethyl. Organic sulfonates are described in Cahn et al., “Surfactants and Detersive Systems”, in Encyclopedia of Chemical Technology, Vol. 22, pp. 347-360(1983) and McCutcheon, Synthetic Detergents, (1950) pp. 120-151. Preferably organic sulfonates selected from the group consisting of alkyl aryl sulfonates, alpha-olefin sulfonates, petroleum sulfonates and naphthalene sulfonates are used.

Since it is preferred to operate the hydrolysis process at temperatures as low as possible, it is preferred to use quaternary ammonium salt as the activating agent. Preferably the polyurethane is reacted with water, the base and the catalyst in the hydrolysis process at a temperature of from 80° C. to 200° C., preferably 90° C. to 180° C., more preferred 95° C. to 170° C. and most preferred 100° C. to 160° C. If the temperature is too low, the yields are insufficient. Too high temperatures are inefficient from an economic point of view and might case side reactions, forming unwanted by-products.

Preferably the polyurethane is reacted with water, the base and the catalyst for 1 minute to 14 hours, preferably 10 min to 12 hours, especially preferred 20 min to 11 hours and most preferred 30 min to 10 hours.

While water functions as a reactant in the desired polyurethane hydrolysis reaction and thus does not need to be present in stoichiometric excess relative to the urethane functional groups in the polymer to be hydrolyzed, it will generally be desirable to utilize a substantial quantity of water in order that it may conveniently serve as a reaction medium and solvent or carrier for the strong base and activating agent. For these reasons, the water is preferably present in condensed (liquid) form. Typically, the weight ratio of polyurethane to water is from 3:1 to 1:15.

The hydrolysis is preferably conducted at atmospheric pressure, although superatmospheric pressures may be employed, if desired. Optionally, a water-miscible or water-immiscible solvent such as alcohol, ketone, ester, ether, amide, sulfoxide, halogenated hydrocarbon, aliphatic hydrocarbon, or aromatic hydrocarbon may be present in the reaction mixture to facilitate the hydrolysis process or to aid in recovering the reaction products.

The hydrolysis reaction may be carried out in a batch, continuous, or semi-continuous manner in any appropriate vessel or other apparatus (for example, a stirred tank reactor or screw extruder) whereby the polyurethane may be contacted with water in the presence of the base and activating agent. It will generally be preferred to agitate or stir the reaction components so as to assure intimate contact, rapid hydrolysis rates, and adequate temperature control.

Just before, we referred to the recycled polyol which was obtained by hydrolysis of a polyurethane, comprising contacting said polyurethane with water in the presence of a base-catalyst-combination (I). In the following part, we refer to the recycled polyol which was obtained by hydrolysis of a polyurethane, comprising contacting said polyurethane with water in the presence of a base-catalyst-combination (II), (II) comprises strong inorganic base having a pK_{b} value at 25° C. of <1, and as catalyst a quaternary ammonium salt containing an ammonium cation containing 6 to 14 carbon atoms if the ammonium cation does not comprise a benzyl residue or containing 6 to 12 carbon atoms if the ammonium cation comprises a benzyl residue.

The bases used there are strong inorganic bases having a pK_{b} value at 25° C. of below 1, preferably 0.5 to −2, more preferred 0.25 to −1.5 and most preferred 0 to −1. Inorganic bases are bases that do not comprise CH bonds.

Particular preferred the strong base is selected from the group consisting of alkali metal hydroxides, alkali metal oxides, alkaline earth metal hydroxides, alkaline earth metal oxides and mixtures thereof. Preferred alkali metals are selected from the group consisting of Na, K and Li and mixtures thereof, most preferred Na and K and mixtures thereof. Preferred alkaline earth metals are selected from the group consisting of Be, Mg, Ca, Sr, Ba and mixtures thereof, most preferred Mg and Ca and mixtures thereof. Most preferred alkali metals selected from the group consisting of potassium or sodium and mixtures thereof are used.

Use of the bases described before allows to run the hydrolysis process with higher yields at lower temperatures compared to prior art processes and thus, significantly contributes to a reduction of the operating costs.

The amount of base in the reaction mixture must be sufficient to catalyze the desired hydrolysis of the polyurethane at a practicable rate. Preferably the weight ratio of base to polyurethane is from 0.01 to 25, more preferred 0.1 to 15, even more preferred 0.2 to 10 and most preferred 0.5 to 5. The base is preferably used in form of a base solution comprising a base and water. For an efficient conversion rate, it is particular preferred if the concentration of base in the base solution is higher than or equal to 5 weight %, based on the weight of the base solution, preferably 5 to 70 weight percent, more preferred 5 to 60 weight percent, even more preferred 10 to 50 weight percent, particular preferred 15 to 40 weight percent and most preferred 20 to 40 weight percent.

Quaternary ammonium salts are used as phase transfer catalysts in the hydrolysis process. Although the addition of even trace amounts of these catalysts will accelerate the hydrolysis rate, it is preferred that at least 0.5 weight percent catalyst, based on the weight of the polyurethane are used, more preferably 0.5 to 15 weight percent, even more preferred 1 to 10 weight percent, particular preferred more 1 to 8 weight percent, especially preferred 1 to 7 and most preferred 1 to 6 weight percent.

The quaternary ammonium salts useful in the hydrolysis process include those organic nitrogen-containing compounds in which the molecular structure includes a central positively-charged nitrogen atom joined to four organic (i.e., hydrocarbyl) groups, i.e. the ammonium cation, and a negatively charged anion such as halide, preferably chloride, bromide, hydrogen sulfate, alkyl sulfate, preferably methylsulfate and ethylsulfate, carbonate, hydrogen carbonate, carboxylate, preferably acetate, or hydroxide.

Quaternary ammonium salts containing an ammonium cation containing a total of 6 to 14 carbon atoms if the ammonium cations do not comprise a benzyl residue, respectively 6 to 12 carbon atoms if the ammonium cations comprise a benzyl residue, have been found to be most effective in the hydrolysis process. In contrast to the teachings of U.S. Pat. No. 5,208,379, the inventors found out that yields significantly decrease if for the same reaction temperature ammonium cation containing a higher number of carbon atoms are used. The same is true if the number of carbon atoms is below 6.

Catalyst that have proven to be highly efficient and thus are preferably used in the hydrolysis process are quaternary ammonium salts having the general structure R₁ R₂ R₃ R₄ NX wherein R₁, R₂, R₃, and R₄ are the same or different and are hydrocarbyl groups selected from alkyl, aryl, and arylalkyl and X is selected from the group consisting of halide, preferably chloride and/or bromide, hydrogen sulfate, alkyl sulfate, preferably methylsulfate and ethylsulfate, carbonate, hydrogen carbonate, carboxylate, preferably acetate, or hydroxide.

Preferably
R₁ to R₃ are the same or different and are alkyl groups with 1 to 6, preferably 1 to 5, more preferred 1 to 4, even more preferred 1 to 3, especially preferred 1 or 2 and most preferred 1 carbon atoms, wherein the alkyl groups may be linear, branched, cyclic, saturated or unsaturated, most preferred are linear, saturated alkyl groups,
R₄ is selected from the group consisting of alkyl groups with 3 to 11, preferably 3 to 10, more preferred 3 to 8, most preferred 4 to 6 carbon atoms, aryl groups with 6 to 11, preferably 6 to 10, and most preferred 6 to 8 carbon atoms, and aralkyl groups with 7 to 11, preferably 7 to 10, and most preferred 7 to 9 carbon atoms, wherein the alkyl groups may be linear, branched, cyclic, saturated or unsaturated, most preferred are linear, saturated alkyl groups, and
X is selected from the group consisting of halide, preferably chloride and/or bromide, hydrogen sulfate, alkyl sulfate, preferably methylsulfate and ethylsulfate, carbonate, hydrogen carbonate, acetate or hydroxide.

In a first preferred embodiment the catalyst is a quaternary ammonium salt having the general structure R₁ R₂ R₃ R₄ NX, wherein R₄ is different from a benzyl residue and R₁ to R₄ are selected such that the sum of carbon atoms in the quaternary ammonium cation is 6 to 14, preferably 7 to 14, more preferred 8 to 13. These catalysts have been found to be very efficient at reaction temperatures below or equal to 140° C.

In a second preferred embodiment the catalyst is a quaternary ammonium salt having the general structure R₁ R₂ R₃ R₄ NX wherein R₄ is a benzyl residue and R₁ to R₃ are selected such that the sum of carbon atoms in the quaternary ammonium cation is 6 to 12, preferably 7 to 12, more preferred 8 to 11. These catalysts have also been found to be very efficient at reaction temperatures below or equal to 140° C.

Most preferred quaternary ammonium salts appropriate for use as the activating agent in the hydrolysis process include benzyltrimethylammonium chloride, tributyl methyl ammonium chloride.

Preferably the polyurethane is reacted with water, the base and the catalyst in the hydrolysis process at a temperature of from 80° C. to 200° C., preferably 90° C. to 180° C., more preferred 95° C. to 170° C. and most preferred 100° C. to 160° C. If the temperature is too low, the yields are insufficient. Too high temperatures are inefficient from an economic point of view and might cause side reactions, forming unwanted by-products.

Preferably the polyurethane is reacted with water, the base and the catalyst for 1 minute to 14 hours, preferably 10 minutes to 12 hours, especially preferred 20 minutes to 11 hours and most preferred 30 minutes to 10 hours.

While water functions as a reactant in the desired polyurethane hydrolysis reaction and thus does not need to be present in stoichiometric excess relative to the urethane functional groups in the polymer to be hydrolyzed, it will generally be desirable to utilize a substantial quantity of water in order that it may conveniently serve as a reaction medium and solvent or carrier for the strong base and activating agent. For these reasons, the water is preferably present in condensed (liquid) form. Typically, the weight ratio of polyurethane to water is from 3:1 to 1:15.

The hydrolysis is preferably conducted at atmospheric pressure, although superatmospheric pressures may be employed, if desired. Optionally, a water-miscible or water-immiscible solvent such as alcohol, ketone, ester, ether, amide, sulfoxide, halogenated hydrocarbon, aliphatic hydrocarbon, or aromatic hydrocarbon may be present in the reaction mixture to facilitate the hydrolysis process or to aid in recovering the reaction products.

The inventive production of PU foams, preferably flexible PU foams, can be performed by any methods familiar to the person skilled in the art, for example by manual mixing or preferably with the aid of high-pressure or low-pressure foaming machines. The process according to the invention may be performed continuously or batchwise.

A particularly preferred composition for production of polyurethane or polyisocyanurate foam in the context of the present invention has a density of preferably 5 to 800, especially 5 to 300, more preferably 5 to 150 and especially preferably of 10 to 90 kg/m³, and especially has the following composition:

| Component | Proportion by weight |
|---|---|
| Polyol, comprising recycled polyol | 100 |
| catalyst | 0.005 to 10, preferably 0.05 to 5 |
| trimerization catalyst | 0 to 10 |
| Siloxane | 0.01 to 25, preferably 0.1 to 20 |
| Water | 0 to <25, preferably 0.1 to 15 |
| Blowing agent | 0 to 130 |
| Flame retardant | 0 to 70 |
| Fillers | 0 to 150 |
| Further additives | 0 to 20 |
| Isocyanate index: | greater than 15 |

In a preferred embodiment of the invention, it is a feature of the process that the flexible PU foam is a hot-cure flexible PU foam, viscoelastic PU foam, HR PU foam or a hypersoft PU foam.

In a preferred embodiment of the invention, the reaction to produce the PU foams, preferably flexible PU foams is performed using
e) water, and/or
f) one or more organic solvents, and/or
g) one or more stabilizers against oxidative degradation, especially antioxidants, and/or
h) one or more flame retardants, and/or
i) one or more foam stabilizers, preferably based on siloxanes and/or polydialkylsiloxane-polyoxyalkylene copolymers,
and/or
j) one or more further auxiliaries, preferably selected from the group of the surfactants, biocides, dyes, pigments, fillers, antistatic additives, crosslinkers, chain extenders, cell openers, organic esters and/or fragrances.

The invention further provides a PU foam, preferably flexible polyurethane foam, preferably a hot-cure flexible PU foam, viscoelastic PU foam, HR PU foam or hypersoft PU foam, which is obtainable by a process as described above.

An inventive flexible PU foam wherein the foam has a rebound resilience of 1-80%, measured in accordance with DIN EN ISO 8307:2008-03, and/or a foam density of 5 to 150 kg/m³, measured in accordance with ASTM D 3574-11, and/or porosity, optionally after crushing the foams, of 1 to 250 mm water column, in particular 1 to 50 mm water column, measured in accordance with DIN ISO 4638:1993-07, corresponds to a preferred embodiment of the invention.

The invention further provides the use of the inventive PU foam, preferably flexible PU foams as packaging foam, mattress, furniture cushion, automobile seat cushion, headrest, dashboard, automobile interior trim, automobile roof liner, sound absorption material, or for production of corresponding products.

### EXAMPLES

### Production of Hot-Cure Flexible PU Foams (Flexible Slabstock Foam)

For the performance testing of the recycled polyols, the hot-cure flexible PU foam formulations specified in Table 1 were used.

TABLE 1
Formulations for hot-cure flexible PU foam production.

| | Parts by mass (pphp) | |
|---|---|---|
| Formulation 1 | | |
| Polyol¹⁾ | 100 | parts |
| Water | 4.00 | parts |
| KOSMOS ® T9²⁾ | 0.20 | parts |
| DABCO ® DMEA³⁾ | 0.15 | parts |
| TEGOSTAB ® BF2370⁴⁾ | 1.0 | part |
| Desmodur ® T 80⁵⁾ | Variable, Constant Index of 105 | |
| Formulation 2 | | |
| Polyol¹⁾ | 100 | parts |
| Water | 3.00 | parts |
| KOSMOS ® EF⁶⁾ | 0.60 | parts |
| DABCO ® NE1050⁷⁾ | 0.15 | parts |
| TEGOSTAB ® BF 2370LC⁸⁾ | 1.0 | part |

| | |
|---|---|
| Desmodur ® T 80⁵⁾ | Variable, Constant Index of 110 |

¹⁾Polyol 1: Standard virgin polyol Arcol ® 1104 available from Covestro, this is a glycerol-based polyether polyol having an OH number of 56 mg KOH/g and an average molar mass of 3000 g/mol or inventive recycled polyols or non-inventive recycled polyol. The recycled polyols are obtained by chemical recycling from flexible polyurethane foams. The recycled polyols were obtained by the procedures described in the following paragraphs.
²⁾KOSMOS ® T9, available from Evonik Industries: tin(II) salt of 2-ethylhexanoic acid.
³⁾DABCOR DMEA: dimethylethanolamine, available from Evonik Industries. Amine catalyst for production of polyurethane foams.
⁴⁾Polyether-modified polysiloxane, available from Evonik Industries.
⁵⁾Tolylene diisocyanate T 80 (80% 2,4 isomer, 20% 2,6 isomer) from Covestro, 3 mPa · s, 48% NCO, functionality 2.
⁶⁾KOSMOS ® EF, emission free metal catalyst, available from Evonik Industries: tin(II) salt of ricinoleic acid
⁷⁾DABCO ® NE1050: low emission amine catalyst, available from Evonik Industries.
⁸⁾Low emission polyether-modified polysiloxane with <0.03 wt % of total cyclic siloxanes, available from Evonik Industries.

### Production of Recycled Polyols

### Recycled Polyol 1 (Non-Inventive)

The non-inventive recycled polyol 1 was produced following a procedure published by H&S Anlagentechnik in 2012:

https://www.dbu.de/OPAC/ab/DBU-Abschlussbericht-AZ-29395.pdf

A Reactor from Parr instrumental company equipped with a glass in liner and a mechanical stirrer, was charged with 300.2 g of compressed polyurethane foam pieces (ca. 1 cm×1 cm). The used polyurethane foam was produced according to Formulation 1, Table 1 by using the conventional polyol Arcol®1104.

152.64 g of the polyol Arcol®1104, 75.63 g phthalic acid and 11.97 g hydrogen peroxide (30 wt % in water) were added to the foam pieces. The reaction mixture was heated to 250° C. inner-temperature. The reaction was kept under this condition for 5 hours at an inner-temperature between 237° C. and 256° C. After the heating was stopped the second portion of 140.63 g Arcol®1104 was added at 160° C. under nitrogen atmosphere. At 80° C. the reaction mixture was decanted and then cooled down to room temperature. The cooled and decanted reaction mixture was used as non-inventive recycled polyol 1. The process was repeated to generate a sufficient quantity recycled polyol for the foaming experiments.

### Recycled Polyol 2 (Inventive)

The inventive recycled polyol 2 was obtained by hydrolysis of a polyurethane with water in the presence of a base-catalyst-combination comprising a base having a pK_{b} value at 25° C. of from 1 to 10, and a catalyst selected from the group consisting of quaternary ammonium salts containing an ammonium cation containing 6 to 30 carbon atoms:

A reactor from Parr instrumental company equipped with a PTFE liner and a mechanical stirrer, was charged with 25 g of compressed polyurethane foam pieces (ca. 1 cm×1 cm). The used polyurethane foam was produced according to Formulation 1, Table 1 by using the conventional polyol Arcol® 1104. Then 75 g of a saturated K₂CO3 solution (pK_{b} value of 3.67 at 25° C.) was added. Thereafter the catalyst tetrabutylammonium hydrogen sulfate was added at 5 wt %, the reactor was closed and heated to an inner-temperature of 150° C. for 14 h. After the reaction time of 14 h ended the mixture was allowed to cool down, the reactor was opened, and the reaction mixture was transferred into a round-bottom flask. The water was removed by evaporation and the remaining reaction mixture was extracted with cyclohexane. The cyclohexane solution was washed with 1N aqueous HCl solution, dried over magnesium sulfate and the cyclohexane was removed by evaporation. The resulting liquid is the inventive recycled polyol 2 and was used for the foaming experiments. The process was repeated to generate a sufficient quantity recycled polyol for the foaming experiments.

### Recycled Polyol 3 (Inventive)

The inventive recycled polyol 3 was obtained by hydrolysis of a polyurethane with water in the presence of a base-catalyst-combination comprising a strong inorganic base having a pK_{b} value at 25° C. of <1, and as catalyst a quaternary ammonium salt containing an ammonium cation containing 6 to 14 carbon atoms if the ammonium cation does not comprise a benzyl residue or containing 6 to 12 carbon atoms if the ammonium cation comprises a benzyl residue:

A reactor from Parr instrumental company equipped with a PTFE liner and a mechanical stirrer, was charged with 25 g of compressed polyurethane foam pieces (ca. 1 cm×1 cm). The used polyurethane foam was produced according to Formulation 1, Table 1 by using the conventional polyol Arcol® 1104. 75 g of a sodium hydroxide solution (20 wt % in water) was added. Thereafter the catalyst tributylmethylammonium chloride was added at 2.5 wt %, the reactor was closed and heated to an inner-temperature of 130° C. for 14 h. After the reaction time of 14 h ended, the mixture was allowed to cool down, the reactor was opened, and the reaction mixture was transferred into a round-bottom flask. The water was removed by evaporation and the remaining reaction mixture was extracted with cyclohexane. The cyclohexane solution was washed with 1 N aqueous HCl solution, dried over magnesium sulfate and the cyclohexane was removed by evaporation. The resulting liquid is the inventive recycled polyol 3 and was used for the foaming experiments. The process was repeated to generate a sufficient quantity recycled polyol for the foaming experiments.

### General Procedure for Production of the Foam Samples

For each foaming test 300 g or 400 g of polyol was used; the other formulation constituents were recalculated accordingly. 1.00 part of a component denoted 1.00 g of this substance per 100 g of polyol for example.

The foaming was carried out in the so-called manual mixing process. Formulation 1 or formulation 2 as specified in table 1 were used. To this end, a paper cup was charged with the different polyols, the respective amine catalyst, the tin catalyst tin(II) 2-ethylhexanoate, water and a foam stabilizer, and the contents were mixed at 1000 rpm for 60 seconds with a disc stirrer. After the first stirring the isocyanate (TDI) was added to the reaction mixture and stirred at 2500 rpm for 7 s and then the reaction mixture was immediately transferred into a paper-lined box (30 cm×30 cm base area and 30 cm height). After being poured in, the foam rose in the foaming box. In the ideal case, the foam blew off on attainment of the maximum rise height and then fell back slightly. This opened the cell membranes of the foam bubbles and an open-pore cell structure of the foam was obtained. Defined foam bodies were cut out of the resulting hot-cure flexible PU foam blocks and were analyzed further.

### Characterization of the Flexible PU Foams:

The flexible polyurethane foams produced were assessed according to the following foam properties a) to l):
a) Fallback of the foam after the end of the rise phase (=settling): The settling, or the further rise, is found from the difference of the foam height after direct blow-off and after 3 minutes after foam blow-off. The foam height is measured at the maximum in the middle of the foam crest by means of a needle secured to a centimeter scale. A positive value here describes the settling of the foam after blow-off; a negative value correspondingly describes further rise of the foam after the blow off.
b) Foam height: The height of the freely risen foam formed after 3 minutes. Foam height is reported in centimeters (cm).
c) Rise time: The period of time between the end of mixing of the reaction components and the blow-off of the polyurethane foam. The rise time is reported in seconds (s).
d) Porosity by dynamic pressure measurement: The gas permeability of the foam was determined in accordance with DIN EN ISO 4638:1993-07 by a dynamic pressure measurement on the foam. The dynamic pressure measured was reported in mm water column, and lower dynamic pressure values characterize a more open foam. The values were measured in the range from 0-300 mm water column. The dynamic pressure was measured by means of an apparatus comprising a nitrogen source, reducing valve with pressure gauge, flow regulating screw, wash bottle, flow meter, T-piece, applicator nozzle and a graduated glass tube filled with water. The applicator nozzle has an edge length of 100×100 mm, a weight of 800 g, an internal diameter of the outlet opening of 5 mm, an internal diameter of the lower applicator ring of 20 mm and an external diameter of the lower applicator ring of 30 mm. The measurement is carried out by setting the nitrogen admission pressure to 1 bar by means of the reducing valve and setting the flow rate to 480 I/h. The amount of water in the graduated glass tube is set so that no pressure difference is built up and none can be read off. For measurement on the test specimen having dimensions of 250×250×50 mm, the applicator nozzle is laid onto the corners of the test specimen, flush with the edges, and also once onto the (estimated) middle of the test specimen (in each case on the side having the greatest surface area). The result is read off when a constant dynamic pressure has been established. The final result is calculated by forming the average of the five measurements obtained.
e) Number of cells per cm (cell number): This is determined visually on a cut surface (measured to DIN EN 15702:2009-04).
f) Compression hardness CLD, 40% to DIN EN ISO 33861:1997+A1:2010. The measured values are reported in kilopascals (kPa).
g) Constant Deflection Compression Set (also commonly called compression set) Five test specimens each of size 5 cm×5 cm×2.5 cm were cut out of the finished foams. The starting thickness was measured. Compression set was measured no earlier than 72 h after production in accordance with DIN EN ISO 1856:2018-11. The test specimens were placed between the plates of the deforming device and were compressed by 90% of their thickness (i.e. to 2.5 mm). Within 15 minutes, the test specimens were placed into an oven at 70° C. and left therein for 22 h. After this time, the apparatus was removed from the oven, the test specimens were removed from the apparatus within 1 min, and they were placed on a wood surface. After relaxation for 30 min, the thickness was measured again and the compression set was calculated and results are reported as a percentage of the original thickness: DVR=(d0−dr)/d0×100%
h) Tensile strength and elongation at break to DIN EN ISO 1798:2008-04. The measurements of tensile strength are reported in kilopascals (kPa), and those of elongation at break in percent (%).
i) Rebound resilience to DIN EN ISO 8307: 2008-03. The measurements are reported in percent (%).
j) Emission profile at room temperature according to DIN EN ISO 16000-9:2008-04. The materials are characterized here with regard to the type and the amount of the organic substances emitting therefrom.

The analysis method serves to ascertain emissions from materials that are used in furniture and mattresses. This is done by using test chambers to measure the emissions at room temperature.

### Analysis

### Test Specimen: Sample Preparation, Sampling and Specimen Dimensions

The reaction mixture is transferred into a box (30 cm×30 cm base area and 30 cm height) which is covered by a PE plastic bag which is open at the top. After being poured in, the foam rose in the foaming box. In the ideal case, the foam blew off on attainment of the maximum rise height and then fell back slightly. This opened the cell membranes of the foam bubbles and an open-pore cell structure of the foam was obtained. After the foam has risen and blown off, the PE bag is closed 3 min after the blow-off. The foam is stored in this way at room temperature for 12 hours in order to enable complete reaction, but simultaneously in order to prevent premature escape of VOCs. Subsequently, the PE bag is opened, and a 7 cm×7 cm×7 cm cube is taken from the centre of the foam block and immediately wrapped in aluminium foil and sealed airtight in a PE bag. It was then transported to the analytical laboratory, and the foam cube was introduced into a cleaned 30 l glass test chamber. The conditions in the test chamber were controlled climatic conditions (temperature 21° C., air humidity 50%). Half the volume of the test chamber is exchanged per hour. After 24 hours, samples are taken from the test chamber air. Tenax adsorption tubes serve to absorb the VOCs. The Tenax tube is then heated, and the volatile substances released are cryofocused in a cold trap of a temperature-programmable evaporator with the aid of an inert gas stream. After the heating phase and cryofocusing has ended, the cold trap is rapidly heated to 280° C. and the focused substances are evaporated. They are subsequently separated in the gas chromatography separation column and detected by mass spectrometry. Calibration with reference substances permits a semi-quantitative estimate of the emission, expressed in “μg/m”. The quantitative reference substance used for the VOC analysis (VOC value) is toluene. Signal peaks can be assigned to substances using their mass spectra and retention indices. The following equipment is used for the analysis: Gerstel, D-45473 Muhlheim an der Ruhr, Eberhard-Gerstel-Platz 1, Germany, TDS-3/KAS-4, Tenax® desorption tubes, Agilent Technologies 7890A (GC)/5975C (MS), column: HP Ultra2 (50 m, 0.32 mm, 0.52 μm), carrier gas: helium. More specific procedural instructions can be taken from DIN EN ISO 16000-9:2008-04.
k) Odor testing of the resulting foams. The finished foams were packed in odor-neutral plastic bags and stored under airtight conditions. For the odor assessment of the foam, cubes measuring 10 cm×10 cm×10 cm were cut out and transferred to jars with a volume of 1 liter, from which the samples were smelled. The jars were closed with a screw lid. The odor test took place after storing the jars for 24 hours at 22° C. The odor test was assessed by a panel of 13 trained odor testers. They were questioned here about the intensity of the odor, a low odor level was rated +, moderate odor ++, and high odor +++.

l) Emission of aldehydes according to VDA 275 (July 1994) by using the DNPH derivatization method:
In the method, test specimens having a certain mass and size are secured above distilled water in a closed 1 L glass bottle and stored for a defined period at constant temperature. The bottles are subsequently cooled down and the absorbed aldehydes are determined in the distilled water. The amount of aldehydes determined is based on the dry weight of the foam sample (mg/kg).
After the foams have been taken out of the foaming box, they are stored at 21° C. and about 50% relative humidity for 24 hours. Samples of the foam blocks are then taken at suitable and representative sites distributed uniformly across the width of the (cooled) foam block. The foam samples are then wrapped in aluminum foil and sealed in a polyethylene bag. The samples each have a size of 100×40×40 mm thickness (about 9 g). For each foam block, 3 test specimens are taken for the determination of aldehydes. The sealed samples are sent for direct determination immediately after receipt. The samples are weighed on an analytical balance to an accuracy of 0.001 g before analysis. A 50 ml quantity of distilled water is pipetted into each of the glass bottles used. The samples are introduced into the glass bottle, and the vessel is sealed and kept at a constant temperature of 60° C. in a thermal cabinet for 3 hours. The vessels are removed from the thermal cabinet after the test period. After standing at room temperature for 60 minutes, the samples are removed from the test bottle. This is followed by derivatization by the DNPH method (dinitrophenylhydrazine). For this, 900 μl of the aqueous phase is admixed with 100 μl of a DNPH solution. The DNPH solution is prepared as follows: 50 mg of DNPH in 40 ml of MeCN (acetonitrile) is acidulated with 250 μl of dilute HCl (1:10) and made up to 50 ml with MeCN. On completion of derivatization, a sample is analyzed by means of HPLC. Separation into the individual aldehyde homologues is carried out.

### HPLC Instrument Parameters

The following instrument is used for the analysis:
Agilent Technologies 1260
Chromatography column: Phenomenex Luna250*4.6 mm C18, 5μ particle size
Eluent: water acetonitrile gradient
Detection: UV 365 nm

### Results of the Foaming Experiments

The results of the influence of the recycled polyols according to the invention on foaming process and foam physical properties of the resulting hot-cure flexible PU foams are compiled in the tables below. Hot-cure flexible PU foams were produced following formulation 1, Table 1 with a standard virgin polyol, recycled polyol not inventive and with the inventive recycled polyols 2 and 3

TABLE 2
Foaming results and foam physical properties of the foams with use of different types
of polyols according to formulation 1, table 1. For each foaming test 400 g polyol
were used; the other formulation constituents were recalculated accordingly.

| Foam Sample | #1 | #2 | #3 | #4 | #5 |
|---|---|---|---|---|---|
| Arcol ®1104, OHN 56, | 100 | | | 70 | 70 |
| Reference, (pphp) | | | | | |
| Recycled Polyol 1 (non- | | 100 | | | 30 |
| inventive), OHN 82, (pphp) | | | | | |
| Recycled Polyol 2 (inventive), | | | 100 | 30 | |
| OHN 55, (pphp) | | | | | |
| Index | 105 | 105 | 105 | 105 | 105 |
| Rise time (s) | 122 | — | 123 | 122 | 129 |
| Rise height (cm) | 33.2 | — | 30.4 | 32.8 | 29.4 |
| Settling (cm) | 0.3 | — | 0.1 | 0.2 | 0.1 |
| Cells (per cm) | 12 | — | 12 | 12 | 12 |
| Porosity (mm water column) | 14 | — | 14 | 15 | 89 |
| Hardness CLD 40% | 3.5 | — | 3.0 | 3.4 | 2.5 |
| compression (kPa) | | | | | |
| Elongation (%) | 143 | — | 180 | 140 | 124 |
| Tensile Strength (kPa) | 118 | — | 136 | 125 | 110 |
| Ball Rebound (%) | 38 | — | 38 | 38 | 34 |
| Compression Set 90% 22 h at | 6 | — | 8 | 6 | 32 |
| 70° C. (%) | | | | | |
| Remarks | Standard | Collapse | Standard | Standard | Standard |
| | foam | | foam | Foam | Foam |

The foaming results in Table 2 show that replacing the standard virgin polyol Arcol®1104 by the inventive recycled polyol 2 allows to produce flexible PU foam with comparable foaming processing characteristics to the reference foam #1. Furthermore, the foam physical properties porosity, cell count, ball rebound and compression set of the inventive foam #3 are comparable to the reference foam #1. The physical properties with respect to elongation and tensile strength are even improved by using the inventive recycled polyol #2 compared to the reference foam #1. On the contrary it was not possible to produce any reasonable foam by using 100 pphp of the non-inventive recycled polyol 1, this foam was collapsing (foam #2). Only at reduced use levels of 30 pphp for the non-inventive recycled polyol 1 in combination with the standard virgin Polyol Arcol®1104, a reasonable foam could be obtained (foam #5). But even at this lower use level, the foam physical properties were worse compared to the foam based on 100 pphp of the inventive recycled polyol 2 (foam #3). Foam #5 was significantly more closed than foam #1 or foam #3. Furthermore, the results for compression set (90% at 70° C.), elongation, tensile strength and ball rebound were worse for foam #5 compared to foam #3.

TABLE 3
Foaming results and foam physical properties of the foams with
use of different types of polyols according to formulation 1,
table 1. For each foaming test 300 g of polyol were used; the
other formulation constituents were recalculated accordingly.

| Foam Sample | #6 | #7 | #8 |
|---|---|---|---|
| Arcol ®1104, OHN 56, | 100 | | |
| Reference, (pphp) | | | |
| Recycled Polyol 1 (non- | | 100 | |
| inventive), OHN 82, (pphp) | | | |
| Recycled Polyol 3 (inventive), | | | 100 |
| OHN 54, (pphp) | | | |
| Index | 105 | 105 | 105 |
| Rise time (s) | 117 | — | 122 |
| Rise height (cm) | 24.0 | — | 24.1 |
| Settling (cm) | 0.2 | — | 0.2 |
| Cells (per cm) | 14 | — | 14 |
| Porosity (mm water column) | 15 | — | 10 |
| Hardness CLD 40% | 3.4 | — | 3.5 |
| compression (kPa) | | | |
| Elongation (%) | 160 | — | 150 |
| Tensile Strength (kPa) | 113 | — | 116 |
| Ball Rebound (%) | 43 | — | 43 |
| Compression Set 90% 22 h at | 5 | — | 7 |
| 70° C. (%) | | | |
| Remarks | Standard | Collapse | Standard |
| | foam | | foam |

The foaming results in Table 3 show that replacing the standard virgin polyol Arcol®1104 by the inventive recycled polyol 3 (foam #8) allows to produce flexible PU foam with comparable foaming processing characteristics to the reference foam (#6). Furthermore, all foam physical properties are comparable to the reference foam. On the contrary it was not possible to produce any reasonable foam by using 100 pphp of the non-inventive recycled polyol 1, this foam was collapsing (foam #7).

The results of the influence of the recycled polyols according to the invention on foam emissions at room temperature are compiled in table 4. Hot-cure flexible PU foams were produced following formulation 2, Table 1 by using a standard virgin polyol, a recycled polyol 1 (not inventive), the inventive recycled polyol 2 or the inventive recycled polyol 3.

TABLE 4
Emission and odor testing results of the foams with use of different polyol types
according to formulation 2, Table 1. For each foaming test 300 g of polyol were
used; the other formulation constituents were recalculated accordingly.

| Foam Sample | #9 | #10 | #11 | #12 |
|---|---|---|---|---|
| Arcol ®1104, OHN 56, Reference, | 100 | | | |
| (pphp) | | | | |
| Recycled Polyol 1 (non-inventive), | | 100 | | |
| OHN 82, (pphp) | | | | |
| Recycled Polyol 2 (inventive), OHN | | | 100 | |
| 55, (pphp) | | | | |
| Recycled Polyol 3 (inventive), OHN | | | | 100 |
| 54, (pphp) | | | | |
| Index | 110 | 110 | 110 | 110 |
| Emissions according to DIN EN ISO | 50 | | 140 | 125 |
| 16000-9: 2008-04 (μg/m³) | | | | |
| Odor | ++ | — | ++ | ++ |
| Emission of aldehydes according to | 0.2 | — | 0.2 | 0.2 |
| VDA 275, Formaldehyde (ppm) | | | | |
| Emission of aldehydes according to | 0.3 | — | 0.3 | 0.3 |
| VDA 275, Acetaldehyde (ppm) | | | | |
| Emission of aldehydes according to | 0.3 | — | 0.2 | 0.2 |
| VDA 275, Propionaldehyde (ppm) | | | | |
| Remarks | Standard Foam | No foam | Standard Foam | Standard Foam |

The hot-cure flexible PU foams according to the invention are found to have low emissions if emissions-optimized additives are used. This can be seen in the VOC tests according to DIN EN ISO 16000-9:2008-04. Even though the total emissions are slightly increased when using 100 pphp of the inventive recycled polyol 2 or 3 (from 50 μg/m³ for foam #9 to 140 μg/m³ for foam #11 and 125 μg/m³ for foam #12), the emissions are still well below the typical limits for TVOC of 500 μg/m³. The recycled polyols 2 and 3 are thus suitable for low-emissions formulations. On the contrary it was not possible to produce any reasonable foam by using 100 pphp of the non-inventive recycled polyol 1.

The results in Table 4 show that replacing the standard virgin polyol Arcol®1104 by the inventive recycled polyol 2 or 3 allows to produce flexible PU foam with comparable odor characteristics as well as aldehyde emissions. The emissions of formaldehyde, acetaldehyde and propionaldehyde, measured according to VDA 275, are in a comparable range for foam #9, foam #11 and foam #12.

1. A process for producing PU foams, the process comprising:
reacting
(a) at least one polyol component, comprising a recycled polyol
with
(b) at least one isocyanate component
in the presence of
(c) at least one or more catalysts that catalyze an isocyanate-polyol and/or isocyanate-water reactions and/or isocyanate trimerization, and
(d) optionally further additives,
wherein the recycled polyol was obtained by hydrolysis of a polyurethane, comprising contacting said polyurethane with water in the presence of a base-catalyst-combination (I) or (II), wherein
(I) comprises a base having a pK_{b} value at 25° C. of from 1 to 10, and at least one catalyst selected from the group consisting of quaternary ammonium salts containing an ammonium cation containing 6 to 30 carbon atoms and organic sulfonates containing at least 7 carbon atoms, and
(II) comprises a strong inorganic base having a pK_{b} value at 25° C. of <1, and as a catalyst a quaternary ammonium salt containing an ammonium cation containing 6 to 14 carbon atoms if the ammonium cation does not comprise a benzyl residue or containing 6 to 12 carbon atoms if the ammonium cation comprises a benzyl residue.

2. The process of claim 1, wherein the base-catalyst-combination (I) comprises a base selected from the group consisting of alkali metal phosphates, alkali metal hydrogen phosphates, alkali metal carbonates, alkali metal silicates, alkali metal hydrogen carbonates, alkali metal acetates, alkali metal sulfites, ammonium hydroxide, and mixtures thereof.

3. The process of claim 1, wherein the base-catalyst-combination (II) comprises a strong inorganic base selected from the group consisting of alkali metal hydroxides, alkali metal oxides, alkaline earth metal hydroxides, alkaline earth metal oxides, and mixtures thereof.

4. The process according to claim 1, wherein the reaction is performed with use of (d) further additives, comprising
(e) water, and/or
(f) one or more organic solvents, and/or
(g) one or more stabilizers against oxidative degradation, and/or
(h) one or more flame retardants, and/or
(i) one or more foam stabilizers,
and/or
j) one or more further auxiliaries.

5. The process according to claim 1, wherein the PU foam is a flexible PLU foam.

6. The process according to claim 1, wherein the reaction is performed with use of (d) further additives comprising one or more foam stabilizers according to the following formula (2): Formula (2): [R^{I}₂R^{II}SiO₂]ₐ[R^{I}₃SiO_{1/2}]_{b}[R^{I}₂SiO_{2/2}]_{c}[R^{I}R^{II}SiO_{2/2}]_{d}[R^{III}SiO_{3/2}]ₑ[SiO_{4/2}]_{f}G_{g} with
a=0 to 12,
b=0 to 8,
c=0 to 250,
d=0 to 40,
e=0 to 10,
f=0 to 5,
g=0 to 3,
where:
$$\begin{matrix}a + b + c + d + e + f + g > 3 \\ a + b \geq 2\end{matrix}$$
G=at least one independently same or different radical selected from the group consisting of
(O_{1/2})ₙSiR^{I}ₘ—CH₂CHR^{V}—R^{IV}—CHR^{V}CH₂—SiR^{I}ₘ(O_{1/2})ₙ,
(O_{1/2})ₙSiR^{I}ₘ—CH₂CHR^{V}—R^{IV}—CR^{V}═CH₂, and
(O_{1/2})ₙSiR^{I}ₘ—CH₂CHR^{V}—R^{IV}—CR^{V}═CR^{V}—CH₃,
R^{IV}=independently same or different divalent organic radicals, optionally interrupted by ether-, ester- or amide-groups and optionally bearing OH functions or (—SiR^{I}₂O—)ₓSiR^{I}₂-groups,
x=1 to 50,
R^{V}=at least one independently same or different radical, selected from the group consisting of alkyl radicals having 1-16 carbon atoms, aryl radicals having 6-16 carbon atoms, and hydrogen,
where:
$$\begin{matrix}n = 1 or 2. \\ m = 1 or 2. \\ n + m = 3.\end{matrix}$$
R^{I}=at least one same or different radical, selected from the group consisting of alkyl radicals having 1-16 carbon atoms, aryl radicals having 6-16 carbon atoms, hydrogen, and —OR^{VI}, saturated or unsaturated,
R^{II}=independently identical or different polyethers obtainable from the polymerization of ethylene oxide, propylene oxide, and/or other alkylene oxides of the general formula (3) or an organic radical according to formula (4)
(R^{VII})ₕ—O—[C₂H₄O]ᵢ—[C₃H₆O]ⱼ—[(CR^{VIII}₂CR^{VIII}₂O]ₖ—R^{IX} Formula (3)
—Oₕ—R^{X} Formula (4)
where
h=0 or 1,
R^{VII}=divalent organic radical, optionally substituted with —OR^{IV} or a divalent organic radical of type CₚH₂ₚ,
i=0 to 150,
j=0 to 150,
k=0 to 80,
p=1-18,
where
$$i + j + k \geq 3.$$
R^{III}=at least one same or different radical, selected from the group consisting of alkyl and aryl radicals, saturated or unsaturated, unsubstituted or substituted with hetero atoms,
R^{VI}=at least one same or different radical, selected from the group consisting of alkyl radicals having 1-16 carbon atoms, aryl radicals having 6-16 carbon atoms, saturated or unsaturated, and hydrogen,
R^{VIII}=at least one same or different radical, selected from the group consisting of alkyl radicals having 1-18 carbon atoms and optionally bearing ether functions or substitution with hetero atoms, aryl radicals having 6-18 carbon atoms and optionally bearing ether functions, and hydrogen,
R^{IX}=at least one same or different radical, selected from the group consisting of hydrogen, alkyl, —C(O)—R^{XI}, —C(O)O—R^{XI}, —C(O)NHR^{XI}, saturated or unsaturated, optionally substituted with hetero atoms,
R^{X}=at least one same or different radical, selected from the group consisting of alkyl radicals, and aryl radicals, saturated or unsaturated, and optionally bearing one or more OH, ether, epoxide, ester, amine or/and halogen substituents,
R^{XI}=at least one same or different radical, selected from the group consisting of alkyl radicals having 1-16 carbon atoms, and aryl radicals having 6-16 carbon atoms, saturated or unsaturated.

7. The process according to claim 1, wherein the at least one or more catalysts (c) is selected from the group consisting of nitrogen-containing compounds and compounds of the general formula 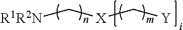
where
X represents oxygen, nitrogen, hydroxyl, amines (NR³ or NR³R⁴), or urea (N(R⁵)C(O)N(R⁶) or N(R⁵)C(O)NR⁶R),
Y represents amine NR⁸R⁹ or ether OR⁹,
R^{1,2} represent identical or different aliphatic or aromatic linear or cyclic hydrocarbon radicals having 1-8 carbon atoms optionally bearing an OH-group or representing hydrogen,
R³⁻⁹ represent identical or different aliphatic or aromatic linear or cyclic hydrocarbon radicals having 1-8 carbon atoms optionally bearing an OH or a NH or NH₂ group or representing hydrogen,
where
m=0 to 4,
n=2 to 6,
i=0 to 3.

8. The process according to claim 1, wherein the at least one or more catalysts (c) is selected from the group consisting of low-emission amines and the low-emission compounds containing one or more tertiary amine groups bearing a functionality reactive with a polyurethane matrix.

9. The process according to claim 1, wherein the at least one or more catalysts (c) is selected from the group consisting of the metal-organic or organometallic compounds, metal-organic or organometallic salts, organic metal salts, inorganic metal salts, and from the group of charged or uncharged metallic coordination compounds.

10. The process according to claim 1, wherein the recycled polyol content is >25% by weight based on the total polyol content.

11. A PU foam wherein it is obtained by the process according to claim 1.

12. The PU foam according to claim 11, wherein the foam is a flexible PU foam and has a rebound resilience of 1-80%, measured in accordance with DIN EN ISO 8307:2008-03, and/or a foam density of 5 to 800 kg/m³, measured in accordance with ASTM D 3574-11, and/or a porosity of 1 to 250 mm water column, measured in accordance with DIN ISO 4638:1993-07.

13. A method for manufacturing products containing a PU foam, the method comprising:
constructing the products with a PU foam according to claim 11, and wherein the products comprise a packaging foam, mattress, furniture cushion, automobile seat cushion, headrest, dashboard, automobile interior trim, automobile roof liner, sound absorption material, and corresponding products.

14. The process according to claim 4, wherein the one or more stabilizers against oxidative degradation are antioxidants.

15. The process according to claim 4, wherein the one or more foam stabilizers are based on siloxanes and/or polydialkylsiloxane-polyoxyalkylene copolymers.

16. The process according to claim 4, wherein the one or more further auxiliaries are at least one selected from the group consisting of surfactants, biocides, dyes, pigments, fillers, antistatic additives, crosslinkers, chain extenders, cell openers, organic esters, and fragrances.

17. The process according to claim 5, wherein the flexible PU foam is a hot-cure flexible PU foam, viscoelastic PU foam, an HR PU foam, or a hypersoft PU foam.

18. The process according to claim 6, wherein a=0 to 8, b=0 to 2, c=1.5 to 150, d=0 to 20, e=0 to 6, f=0, and g=0 to 2.

19. The process according to claim 6, wherein R^{IV}=same or different divalent organic radicals having 2-30 carbon atoms, optionally interrupted by ether, ester or amide-groups and optionally bearing OH functions, or (—SiR^{I}₂O—)ₓSiR^{I}₂ groups.

20. The process according to claim 6, wherein x=1 to 10.
